(19) United States
(12) Patent Application Publication
(10) Pub. No.: US 2025/0392138 A1
(43) Pub. Date: Dec. 25, 2025

(54) BATTERY MANAGEMENT INTEGRATED CIRCUIT AND SYSTEM, BATTERY PACK USING THE BATTERY MANAGEMENT INTEGRATED CIRCUIT, COMPUTER PROGRAM PRODUCT AND RELATED METHOD

(71) Applicant: Earth Top International Enterprises Ltd., Tortola (VG)

(72) Inventors: TSAI-CHUNG YU, Taipei (TW); Nan-Huei Lee, Taipei (TW)

(21) Appl. No.: 19/050,265

(22) Filed: Feb. 11, 2025

Related U.S. Application Data
(60) Provisional application No. 63/553,713, filed on Feb. 15, 2024.

(51) Int. Cl. H02J 7/00

(52) U.S. Cl. CPC H02J 7/0016; H02J 7/0019; H02J 7/0024; H02J 7/00309; H02J 7/0048; H02J 7/005

(57) ABSTRACT

The invention discloses a battery management integrated circuit and system as well as related method. The battery management integrated circuit is configured to connect in parallel to at least one battery cell or a plurality of battery cells connected in series to perform power management. The battery management integrated circuit includes at least one loop switch arranged in a charging loop or a discharging loop of the battery cells, at least one voltage measurement circuit configured to measure an open-loop voltage of each battery cell during the period when the loop switch cuts off the charging or discharging loop, and a management unit configured to determine SOC of each battery cell according to the open-loop voltage of each battery cell. The invention further discloses a battery pack, a computer program product, and a system as well as a method thereof using the battery management integrated circuit.

### BACKGROUND OF THE INVENTION

### Field of the Invention

The present invention relates to a battery configuration and a management system and method thereof, and more particularly to a power battery suitable for high-power apparatus and a management system and method thereof.

### Description of the Prior Art

FIG. 1 shows an open loop of a rechargeable battery unit C (battery cell), whose terminal voltages are Vbat+ and Vbat− respectively. FIG. 2 shows an equivalent circuit of the battery cell C, including an internal resistance Rbat and an open-loop voltage Vopen connected in series to the internal resistance Rbat. The open-loop Vopen represents the equivalent voltage of the battery cell C in an open loop status. The battery cell C may be a ternary lithium battery (Rbat=110 mΩ/Ah, Vopen=4.20V/3.65V/3.00V) or a lithium iron phosphate battery (Rbat=22 mΩ/Ah, Vopen=3.70V/3.00V/2.50V).

FIG. 3 shows a configuration of a conventional battery pack P, which includes a battery cell C, a protection integrated circuit PIC, a power switch S and one or more passive components, wherein the battery cell is a rechargeable battery, and the power switch S may be a transistor switch (such as MOSFET). The battery pack P has terminal voltages VP+ and VP−, wherein the voltage VP+ is connected to one terminal of the protection integrated circuit PIC and one end of the battery cell C, and the voltage VP− is connected to the other terminal of the protection integrated circuit PIC and the other end of the battery cell C. The power switch S is connected between the battery cell C and the voltage VP−, and can be controlled by the protection integrated circuit PIC to be turned on and off to determine whether the battery cell C is connected to the voltage VP−. Preferably, the power switch S is configured to withstand a voltage in the range of 20V to 40V when turned off, and to have a conduction resistance having several mΩ when turned on. In the present disclosure, Ron is used to represent the on-resistance of the switch component.

The protection integrated circuit PIC is connected to the battery cell C by a connection means 10, so that a temperature sensing terminal of the protection integrated circuit PIC can contact with or close to a surface of the battery cell C to measure the temperature of the battery cell C. Therefore, the protection integrated circuit PIC is mainly used to achieve multiple purposes including protection against overcharging or over discharging of the battery cell C, protection against excessive charging current or discharging current, and protection against excessive circuit temperature (caused by battery temperature). In addition to the foregoing protection purposes, the protection integrated circuit PIC will not control the power switch S to be turned OFF.

Conventional gauge IC (GIC) has functions including measurement and calculation, such as measurement for the terminal voltage Vbat of a battery cell C, the battery charging or discharging current Ibat, and the battery temperature Tbat through an external component (e.g. thermistor). Since the gauge IC after production is combined with external components to have specific functions, the gauge IC produced in large quantities cannot be calibrated one by one for the external components. Therefore, directly combining the gauge IC with external components may lead to inaccurate measurement results, which in turn affects the evaluation for the state-of-charge (SOC). SOC can be obtained by the known Coulometric method, voltage method, charge method, current method and the like. According to the calculation formula of power (CV=IT=Q), the estimation of SOC is mainly achieved by five variables, namely capacitance, open-loop voltage, current, time and quantity of electric charge. In practice, the prior art first estimates the SOC based on the charge and discharge ratio over a long period of time, and then uses the estimated SOC to interpret the battery capacity and the quality of the battery.

FIG. 4 schematically shows the battery pack P shown in FIG. 3 being connected to a load system SYS. The GIC is arranged in the load system SYS. A thermistor TH is attached to the battery pack P, and the GIC measures the temperature of the battery pack P through the thermistor TH. In the load system SYS, a detection resistor Rsense (10 mΩ) is arranged on the charging and discharging loop of the battery pack P for the GIC to measure the charging and discharging current. In practice, the thermistor TH and a detection resistor Rsense are both external components of the GIC, and the GIC has not been calibrated for the thermistor TH and the detection resistor Rsense during manufacturing. Therefore, the GIC can only be assumed that these coordinated external components are accurate. In the load system SYS, the conventional GIC cannot measure the terminal voltage Vbat of the battery cell in the battery pack P, and uses the battery pack P temperature to correct the battery terminal voltage, which can only be used to estimate the SOC of the charging and discharging battery cell.

The GIC shown in FIG. 4 mainly provides functions, such as measuring the terminal voltages VP+ and VP− of the battery pack P, measuring the charging and discharging current Ibat of the battery pack P, and measuring the temperature of the battery pack P, so as to evaluate parameters, like SOC. The GIC can be calibrated for the charging and discharging currents Ibat and the terminal voltages VP+ and VP− of the battery pack P.

### SUMMARY OF THE INVENTION

One object of the present invention is to provide a total solution for battery management, comprising a battery management integrated circuit (IC) and system, a battery pack using the battery management IC, a computer program product and methods thereof.

The battery management system of the present invention is configured to manage at least one or more battery cells to discharge for a terminal device or charge via the terminal device, and performs power management by at least one battery management IC connected in parallel to at least one battery cell or connected in parallel to a plurality of battery cells connected in series. The battery management IC measures the at least one battery cell or the plurality of battery cells connected in series to calculate an electrical power of each battery cell, monitors a safety of each battery cell and evaluates a health of each battery cell to collect battery management information of all battery cells, and allows the terminal device authorized to read and display a part of the battery management information to a user of the terminal device, or allows an authorized exclusive battery management apparatus to read complete battery management information so as to select a battery cell that requires update and maintenance. In a different embodiment of the present invention, the terminal device is an electric vehicle, an electric motorbike, a smartphone, a laptop computer, a portable electronic apparatus or other electronic devices.

The battery management integrated circuit of the present invention includes a loop switch. The loop switch has a detection resistor Rsense. The present disclosure uses Rsense to represent the loop switch. The battery management integrated circuit of the present invention can also be electrically connected to one or more loop switches that belong to an external component. The battery management integrated circuit of the present invention can control the loop switch Rsense or an external loop switch to briefly open the charging loop or discharging loop of the battery cell to measure the open-loop voltage Vopen of each battery cell, and then calculate the SOC of each battery cell accordingly.

The battery management IC of the present invention comprises a pair of sensing pins connected in parallel to a temperature sensor, preferably a diode, to coordinate with a temperature difference measurement circuit of the battery management IC, so that the battery management IC does not need to additionally calibrate an external temperature sensing diode for measuring a battery temperature. The battery management integrated circuit of the present invention comprises a plurality of pins, which are used to measure the terminal voltage Vbat of each battery cell, and a balancing resistor Rbalance and a switch Ron connected in series. The pins are connected in parallel to at least one battery cell or a plurality of battery cells connected in series, so that the battery management integrated circuit can synchronously measure the terminal voltage Vbat, the battery temperature Tbat, and the charging current or discharging current Ibat of the battery cell, and calculate an open-loop terminal voltage (or open-loop voltage) Vopen and a battery internal resistance Rbat in each battery cell that are associated with the battery temperature Tbat. The battery management system of the present invention collects battery management information associated with the battery temperature Tbat in each battery cell.

One object of the present invention is to provide a battery management system and method for evaluating a battery health based on a battery internal resistance Rbat, comprising measuring in real time a battery internal resistance Rbat and a battery internal resistance difference ΔRbat by at least one battery management IC, defining a quality of the battery cell by comparing the battery internal resistance Rbat measured in real time and a predetermined battery internal resistance Rbat of the battery cell, monitoring a change in the battery internal resistance difference ΔRbat measured in real time to define a lifetime of the battery cell, and providing the battery internal resistance Rbat measured in real time and the battery internal resistance difference ΔRbat measured in real time to the terminal device which is authorized or an authorized exclusive battery management apparatus, for a user interface to display a health of the battery cell.

In one embodiment, the at least one battery cell managed by the battery management system of the present invention can measure an open-loop voltage Vopen, a battery internal resistance Rbat, a battery internal resistance difference ΔRbat, a terminal voltage Vbat, a battery temperature Tbat and a charge current or discharge current Ibat of the battery cell by a battery management IC, to accordingly define battery management information such as state of charge (SOC), state of health (SOH), remaining usage time, temperature safety, battery quality, and battery health of the battery cell. The battery management system of the present invention can provide the battery management information measured in real time to the terminal device which is authorized or an authorized exclusive battery management apparatus, for a user interface to display at least one part of the battery management information of the battery cell.

In one embodiment, the at least one battery pack managed by the battery management system of the present invention comprises a plurality of battery cells, and is charged or discharged in a form selected from a series form, a parallel form, a series-parallel form and a parallel-series form, and an open-loop voltage Vopen, a battery internal resistance Rbat, a battery internal resistance difference ΔRbat, a terminal voltage Vbat, a battery temperature Tbat and a charge current or discharge current Ibat of each battery cell of the battery pack can be measured by the at least one battery management IC, to accordingly define battery management information such as state of charge (SOC), state of health (SOH), remaining usage time, temperature safety, battery quality, and battery health of the battery pack. The battery management system of the present invention can provide the battery management information measured in real time to the terminal device which is authorized or an authorized exclusive battery management apparatus, for a user interface to display at least one part of the battery management information of the battery pack.

In one embodiment, the battery management system of the present invention further comprises a data processing system. The data processing system establishes a communication with a communication module of the battery management IC to receive the open-loop voltage Vopen, the battery internal resistance Rbat, the battery internal resistance difference ΔRbat, the terminal voltage Vbat, the battery temperature Tbat and the charge current of discharge current Ibat of each battery cell. The data processing system obtains the state of charge (SOC) according to the open-loop voltage Vopen, obtains temperature safety information according to the battery temperature Tbat, obtains the battery quality according to the battery internal resistance Rbat, obtains the cycle life according to the battery internal resistance difference ΔRbat, and monitors an over-charge voltage and over-discharge voltage difference according to the terminal voltage Vbat to obtain the battery performance.

One object of the present invention is to provide a battery pack which comprises a first battery group and a second battery group that are connected in parallel, and at least one battery management IC. Each of the first and second battery groups consists of a battery cell or a plurality of battery cells connected in series. The battery management IC is configured to be connected to the first and second battery groups in parallel, and can control and temporarily open a charge path or a discharge path of the first or second battery group, so as to individually measure an open-loop voltage Vopen and a battery internal resistance Rbat of each battery cell of the first or second battery group to accordingly define battery management information of the battery pack.

One object of the present invention is to provide a battery management system and method configured to manage at least one battery pack or a plurality of battery packs to discharge for a terminal device or charge via the terminal device. Each battery pack includes at least one or a plurality of battery cells connected in series, and at least one battery management IC. The battery management IC individually measures an open-loop voltage Vopen and a battery internal resistance Rbat of each battery cell of each battery pack to accordingly define battery management information of the battery pack, for the battery management system to collect battery management information of each battery pack, select each battery pack or each battery cell for replacement or repair according to a predetermined evaluation standard, and label a position of the battery pack or the battery cell on a display interface of a battery configuration diagram.

One object of the present invention is to provide a battery management system and method executing battery balancing by a battery management IC to maintain battery quality consistency. The battery balancing executed by the battery management IC includes battery balancing between battery cells or battery balancing between battery packs. Wherein, the battery balancing is based on energy storage of a capacitor. An energy storage path or an energy release path is implemented by an electrical connection path with adjacent battery management ICs, and the capacitor can be disposed within the battery management IC or on the electrical connection path between the adjacent battery management ICs.

A battery balancing function can be implemented by the battery management IC according to the present invention, and the life cycle, health and performance of each battery cell can be controlled and improved using the battery management information of the battery cells. The following effects are achieved: the life cycle of each battery cell is improved, and the performance of each battery cell is enhanced; consumers are prevented from having to one-time replace one costly battery pack, and are allowed to measure battery management data for maintaining and protecting each battery cell at all times; The manufacturer of a terminal device can quickly and safely assemble a large-power battery, and is capable of inspecting the battery internal resistance Rbat of each battery cell so as to control the battery quality; Applications of the battery can be extended from products of 10 W (3 hr*3.65 V) to tens of kW, hundreds of kW or even thousands of kW, while significantly reducing safety concerns of the large battery, and promoting the life cycle and the usage performance of the large battery to higher levels.

### BRIEF DESCRIPTION OF THE DRAWINGS

The present invention may be further realized with reference to the following drawings and descriptions. Non-limiting and non-exhaustive examples are described with reference to the following figures. The components in the drawings are not necessarily to actual scale, the emphasis is placed on illustrating the structure and principles.

FIG. 1 is a circuit diagram of a battery unit (battery cell).

FIG. 2 is an equivalent circuit diagram of the battery unit (battery cell) shown in FIG. 1.

FIG. 3 is a configuration diagram of a conventional battery pack, which includes a protection integrated circuit (PIC) and a battery cell.

FIG. 4 is a configuration diagram of the battery pack shown in FIG. 3 connected to a system end, wherein the system end includes a gauge integrated circuit (GIC).

FIG. 5 is a configuration diagram of a customized battery pack of the present invention. The conventional battery pack includes a protection integrated circuit (PIC), a battery cell, and a gauge integrated circuit (GIC).

FIG. 6 is a configuration diagram of the battery pack of the present invention.

FIG. 7 is a block diagram of the battery management integrated circuit of the present invention.

FIG. 8 is a block diagram of a battery pack the present invention, wherein a battery management integrated circuit (GIC) includes a loop switch.

FIG. 9 is a block diagram of another embodiment of a battery pack of the present invention, wherein the Rsense switch is disposed outside a battery management integrated circuit (GIC), and the battery management integrated circuit controls the Rsense switch.

FIG. 10 is a configuration diagram of the battery pack of the present invention, when the Ron switch is turned on and the Rsense switch is turned off, the battery management integrated circuit can measure the terminal voltage Vbat of the battery cell and the terminal voltage Von of the Ron switch.

FIG. 11 is a configuration diagram of the battery pack of the present invention, wherein when the Ron switch is cut off and the Rsense switch is turned on, the battery management integrated circuit can measure the terminal voltage Vbat of the battery cell and the terminal voltage Vsense of the Rsense switch.

FIG. 12 is a configuration diagram of a battery pack having battery cells connected in series according to the present invention.

FIG. 13 is a configuration diagram of a battery pack having battery cells connected in parallel according to the present invention.

FIG. 14 is a configuration diagram of another battery pack having battery cells connected in parallel according to the present invention.

FIG. 15 is a configuration diagram of a battery pack having battery groups connected in parallel according to the present invention.

FIG. 16 is a configuration diagram of another battery pack having battery groups connected in parallel according to the present invention.

FIG. 17 is a configuration diagram of the battery packs shown in FIG. 12 connected in a multiple-series and multiple-parallel configuration.

FIG. 18 is a configuration diagram of the battery packs shown in FIG. 12 in a multiple parallel configuration.

FIG. 19 is a configuration diagram of the battery packs shown in FIG. 15 in a multiple-series and multiple-parallel configuration.

FIG. 20 is a configuration diagram of a battery pack having chargers according to the present invention.

FIG. 21 is a configuration diagram of another battery pack having chargers according to the present invention.

FIG. 22 is a configuration diagram of yet another battery pack according to the present invention.

FIG. 23 illustrates component diagrams showing specific embodiments for implementing the loop switch Rsense according to the present invention.

FIG. 24 is another configuration diagram of the battery pack of the present invention, wherein the Rsense switch is electrically connected to the VP+ terminal of the battery pack.

FIG. 25 is a schematic diagram of the battery pack of the present invention shown in FIG. 24 being used to measure the terminal voltage Vbat of the battery cell and the terminal voltage Von of the Ron switch.

FIG. 26 is a schematic diagram of the battery pack of the present invention shown in FIG. 24 being used to measure the terminal voltage Vbat of a battery cell and the terminal voltage Vsense of an Rsense switch twice.

FIG. 27 illustrates diagrams (A), (B), and (C) of various configurations of battery cells.

FIG. 28 illustrates equivalent circuit diagrams (A), (B) and (C) of the battery cells shown in diagrams (A), (B) and (C) of FIG. 27, respectively.

FIG. 29 shows a circuit diagram of a plurality of battery packs connected in series, wherein each battery pack is connected in parallel to a functional integrated circuit (FIC), and there are synchronous control pins between the functional integrated circuits.

FIG. 30 illustrates configuration diagrams (A), (B), (C) and (D) of the power battery and its equivalent circuit.

FIG. 31 illustrates various circuit diagrams (A), (B), (C) and (D) for balancing.

FIG. 32 is a parallel configuration diagram of battery packs of the present invention, wherein the battery management integrated circuit (GIC) further includes a series balancing circuit and a parallel balancing circuit for a voltage balancing function.

FIG. 33 is a schematic diagram of a battery management system according to an embodiment of the present invention for implementing high-power series balancing management.

FIG. 34 is a schematic diagram of another embodiment of the battery management system of the present invention for implementing high-power series balancing management.

FIG. 35 illustrates the power balancing circuit diagrams (A) and (B) of the battery management system shown in FIG. 33.

FIG. 36 illustrates the power balancing circuit diagrams (A) and (B) of the battery management system shown in FIG. 34.

FIG. 37 illustrates power balancing circuit diagrams (A) and (B) for implementing high-power series balancing management in another embodiment of the battery management system of the present invention.

FIG. 38 illustrates power balancing circuit diagrams (A) and (B) for implementing high-power series balancing management in yet another embodiment of the battery management system of the present invention.

FIG. 39 and FIG. 40 illustrate power balancing circuit diagrams (A) and (B) of a high-power series balancing management of the battery management system of the present invention.

FIG. 41 and FIG. 42 illustrate other power balancing circuit diagrams (A) and (B) of high-power series balancing management of the battery management system of the present invention.

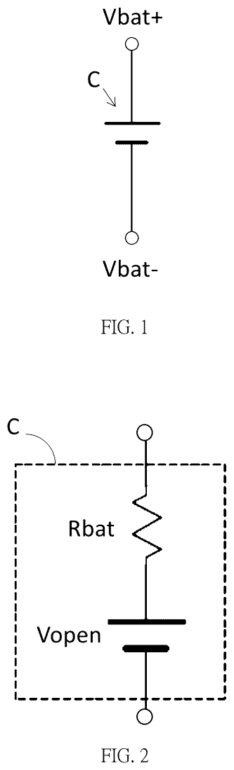

### DETAILED DESCRIPTION OF THE EMBODIMENTS

The present invention will now be described more fully hereinafter with reference to the accompanying drawings, in which specific exemplary embodiments are shown by way of illustration. However, the claimed subject matter may be embodied in many different forms, and thus the construction of the claimed subject matter is not limited to any exemplary embodiment disclosed in this specification. The exemplary embodiments are merely illustrative. Likewise, the present invention is intended to provide a reasonably broad scope for claimed subject matter as claimed or encompassed. Furthermore, the drawings and illustrations in the present disclosure are generally not drawn to scale and are not intended to correspond to actual relative sizes.

For the sake of consistency and ease of understanding, identical features are identified by reference numerals in the exemplary drawings, although not so identified in some instances. However, features in different embodiments may differ in other aspects and should not be narrowly limited to the features shown in the drawings. The terms “first” and “second” in the specification of the present invention and the above drawings are used to distinguish different objects rather than to describe a specific order.

In one embodiment of the present invention, the battery management system and method of the present invention are configured to manage a large-power battery formed by several thousands or even over ten thousand battery cells connected in series and parallel form. The power battery is provided for use of an electric vehicle. The system and method of the present invention provide a total solution based on a low-power consumption and low-internal resistance smart IC. Each battery management IC is in charge of managing a plurality of battery cells connected in series, and performs the operations as follows.
(1) measuring a temperature (for monitoring battery safety) of each battery cell, terminal voltage value/open-loop voltage value (for evaluating the capacity) and a battery current value (for evaluating a remaining battery usage time)
(2) calculating an open-loop voltage Vopen and/or a battery internal resistance Rbat of each battery cell to accordingly define the capacity, quality, cycle life and state of health.
(3) monitoring protection against over-charge, over-discharge, short circuitry and over-temperature of each battery cell.
(4) implementing a balancing circuit so that a voltage difference between a maximum battery voltage and a minimum battery voltage is less than a threshold (for example, 10 mV), and monitoring the battery internal resistor Rbat so as to extend life cycles of all battery cells and enhance battery usage performance.
(5) providing a communication module, so as to transmit battery management data of each battery cell to a data processing system.
(6) providing a large-power battery that can be quickly and safely assembled, and capable of being inspected the battery internal resistance Rbat of each battery cell so as to control the battery quality.

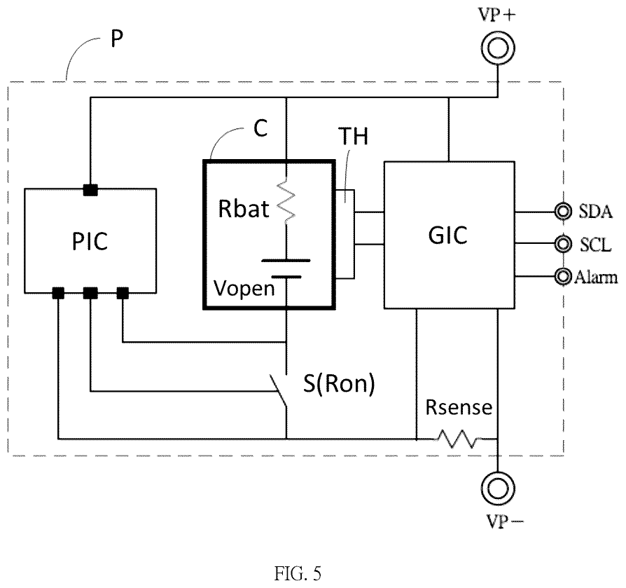

FIG. 5 illustrates a configuration of a customized battery pack P according to the present invention, comprising a rechargeable battery cell C, a protection IC (PIC), a power switch S, a gauge IC (GIC), a detection resistor Rsense, a thermistor TH and other one or more passive components. The gauge IC (GIC) is disposed within the battery pack P, and the thermistor TH is attached to the battery cell C, and the temperature of the battery pack P is detected by the gauge IC. In one embodiment, the detection resistor Rsense is 10 mΩ, the power switch is achieved by one or more transistors. The power switch S is able to withstand a large voltage ranging from 20 to 40 V when turned off and able to have a small Ron resistance, up to mΩ, when turned on.

In the embodiment of the present invention, the open-loop voltage Vopen of the battery cell C is used to determine the capacity (%) of the battery. The charging or discharging current Ibat of the battery cell C is used to evaluate the current consumption and the remaining usage time of the terminal device. The battery internal resistance Rbat is used to determine the quality of the battery cell C. The open-loop voltage Vopen, the battery internal resistance Rbat and the identification information of the battery cell C are used to generate the usage history of the battery cell, including service life, manufacturing information, charging times, etc., which are stored in the non-volatile memory (NVM). In one embodiment, the open-loop voltage Vopen is used to define the precise capacity SOC, and the open loop-voltage Vopen and SOC can further define the battery internal resistance Rbat. In another embodiment, according to the formula Q/I=T, the charge (i.e. SOC) divided by the discharge current Ibat can be used to evaluate how long the battery cell can be used under the same conditions.

In one embodiment, a battery management system is configured to manage a plurality of battery cells to discharge for a terminal device or charge via the terminal device. The battery management system comprises a plurality of battery cells and at least one battery management IC. The plurality of battery cells performs charging or discharging in a form selected from a series form, a parallel form, a series-parallel form and a parallel-series form. The at least one battery management IC performs power management by connecting a battery in series cell or connecting in parallel to a plurality of battery cells connected in series. Wherein, the battery management IC comprises an Rsense switch for opening a charging loop or a discharging loop of the at least one battery cell or the plurality of battery cells connected in series, for the battery management IC to measure an open-loop voltage Vopen of each battery cell and accordingly define state of charge (SOC) of each battery cell.

In one embodiment, a battery management method is used for managing a plurality of battery cells to discharge for a terminal device or charge via the terminal device. The battery management method comprises charging or discharging a plurality of battery cells in a form selected from a series form, a parallel form, a series-parallel form and a parallel-series form; and performing power management by at least one battery management IC connected in parallel to at least one battery cell or by the at least one battery management IC connected in parallel to a plurality of battery cells connected in series. Wherein, the battery management IC includes an Rsense switch disposed on a charging loop or a discharging loop of the a least one battery cell or the plurality of battery cells connected in series, such that the switch is configured to cause the charging loop or the discharging loop opened for the battery management IC to measure an open-loop voltage Vopen of each battery cell and accordingly define state of charge (SOC) of each battery cell.

In one embodiment, a battery management IC, performs power management by connecting in parallel to at least one battery cell or by connecting in parallel to a plurality of battery cells connected in series, the battery management IC comprises a loop switch Rsense, at least one voltage measurement circuit and a management unit. The Rsense switch is disposed on a charging loop or a discharging loop of the at least one battery cell or the plurality of battery cells connected in series. The at least one voltage measurement circuit measures an open-loop voltage of each battery cell when the switch causes the charging loop or the discharging loop opened. The management unit defines state of charge (SOC) of each battery cell according to the open-loop voltage Vopen of each battery cell.

In one embodiment, a battery management system is configured to manage a plurality of battery cells to discharge for a terminal device or charge via the terminal device. The battery management system comprises a plurality of battery cells and at least one battery management IC. The plurality of battery cells performs charging or discharging in a form selected from a series form, a parallel form, a series-parallel form and a parallel-series form. The at least one battery management IC performs power management by connecting in parallel to at least one battery cell or connecting in parallel to a plurality of battery cells connected in series. Wherein, the battery management IC synchronously measures a terminal voltage Vbat and a battery temperature Tbat of each battery cell and a charge current or a discharge current Ibat of each battery cell, and accordingly calculates an open-loop voltage Vopen and a battery internal resistance Rbat of each battery cell associated with the battery temperature Tbat, for the battery management IC to accordingly present for each battery cell the power management including SOC, SOH, and a remaining usage time associated with the battery temperature Tbat.

In one embodiment, a battery management method is used for managing a plurality of battery cells to discharge for a terminal device or charge via the terminal device. The battery management method comprises charging or discharging a plurality of battery cells in a form selected from a series form, a parallel form, a series-parallel form and a parallel-series form; performing power management by at least one battery management IC connected to at least one battery cell in parallel, or by the at least one battery management IC connected in parallel to a plurality of battery cells connected in series; and synchronously measuring a terminal voltage Vbat and a battery temperature That of each battery cell and a charge current or a discharge current Ibat of the battery cell by the battery management IC, and accordingly calculating an open-loop voltage Vopen and a battery internal resistance Rbat of each battery cell associated with a battery temperature Tbat, for the battery management IC to accordingly present for each battery cell the power management including SOC, SOH, and a remaining usage time associated with the battery temperature Tbat.

In one embodiment, a battery management IC performs power management by connecting at least one battery cell in parallel or connecting in parallel to a plurality of battery cells connected in series. The battery management IC comprises at least one voltage measurement circuit, at least one temperature measurement circuit, at least one current measurement circuit and a calculation unit. The at least one voltage measurement circuit measures a terminal voltage Vbat of the battery cell connected in parallel to the battery management IC. The at least one temperature measurement circuit measures a battery temperature Tbat of the battery cell connected in parallel to the battery management IC. The at least one current measurement circuit measures a charge current or a discharge current Ibat of the battery cell connected in parallel to the battery management IC. The calculation unit calculates an open-loop voltage Vopen and a battery internal resistance Rbat of the battery cell associated with the battery temperature Tbat according to the terminal voltage Vbat of each battery cell, the battery temperature Tbat and the charge current or discharge current Ibat of each battery cell. Wherein, the battery management IC synchronously measures the terminal voltage Vbat, the battery temperature Tbat and the charge current or discharge current Ibat, and the battery management IC presents for each battery cell the power management including SOC, SOH and a remaining usage time associated with the battery temperature Tbat according to the calculated open-loop voltage Vopen and battery internal resistance Rbat.

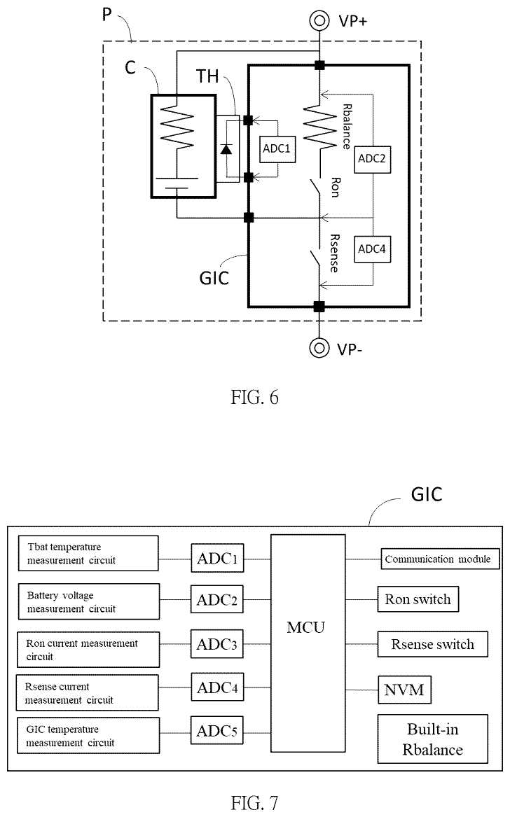

The following further describes various embodiments of the present invention with reference to the drawings. FIG. 6 shows another configuration of the battery pack of the present invention, wherein ADC1, ADC2, and ADC4 are used to measure the battery temperature, the battery terminal voltage, and the terminal voltage of the loop switch Rsense. FIG. 7 shows a block diagram of the battery management integrated circuit of the present invention.

The present invention proposes a combination of a conduction switch Ron, a loop switch Rsense and a balancing resistor Rbalance. By turning on and off the conduction switch Ron and the loop switch Rsense, the open-loop voltage Vopen and the battery internal resistance Rbat can be measured. The balancing resistor Rbalance provides Ibat measurement and limits Ibat within a certain range, and balances the open-loop voltage Vopen when the conduction switch Ron is turned on. The conduction switch Ron and the loop switch Rsense can be calibrated before packaging to accurately measure the battery current. The conduction switch Ron and the loop switch Rsense may be transistor switches, such as MOSFETs. The opened conduction switch Ron and the opened loop switch Rsense are used to measure Vopen. The closed conduction switch Ron and the opened loop switch Rsense are used to calculate Vopen and Rbat as well as balance Vopen.

In the present invention, a battery management integrated circuit GIC connects at least one battery cell C in parallel or connects in parallel to a plurality of battery cells C connected in series. The GIC comprises at least one positive pin and at least one negative pin, at least one pair of sensing pins, a balancing resistor Rbalance and a conduction switch Ron as well as a loop switch Rsense. The at least one positive pin and at least one negative pin are respectively electrically connected to a positive electrode and a negative electrode of a corresponding battery cell. The at least one pair of sensing pins is used for connecting in parallel to a temperature sensor for the corresponding battery cell. The balancing resistor Rbalance and the conduction switch Ron are connected in series for connecting the at least one battery cell in parallel or connecting in parallel to the plurality of battery cells connected in series. The loop switch Rsense is disposed on a charging loop or discharging loop of the at least one battery cell or the plurality of battery cells connected in series.

The GIC further comprises an MCU and at least one voltage measurement circuit, and the at least one voltage measurement circuit measures the terminal voltage Vbat of the battery cell C connected in parallel to the GIC. When the MCU controls the loop switch Rsense to temporarily open the charging loop or the discharging loop and controls the conduction switch Ron to be disconnected, the at least one voltage measurement circuit instantly measures the open-loop voltage Vopen of the corresponding battery cell C, so that the MCU receives the measurement result of the open-loop voltage Vopen via ADC2 (analog-to-digital converter) and defines the SOC of the corresponding battery cell C according to the open-loop voltage Vopen. The MCU can be implemented as a computing unit and a management unit.

In addition to at least one voltage measurement circuit, the GIC further comprises at least one battery temperature measurement circuit, a Ron current measurement circuit, a Rsense current measurement circuit and a GIC temperature measurement circuit. The at least one battery temperature measurement circuit measures the temperature sensor TH of the battery cell C connected in parallel to the GIC to measure the battery temperature Tbat. The Ron current measuring circuit measures the current flowing through the conducting switch Ron. The Rsense current measurement circuit measures the charging current or the discharging current flowing through the loop switch Rsense. The GIC temperature measurement circuit measures the chip temperature of the GIC. The MCU receives measurement results such as the battery temperature, the current flowing through the conduction switch Ron, the current flowing through the loop switch Rsense, and the chip temperature of the GIC through ADC1, ADC3, ADC4, and ADC5 respectively. In one embodiment of the present invention, the GIC synchronously measures the terminal voltage Vbat, the battery temperature Tbat and the charging current or discharging current Ibat, and the MCU calculates the open-loop voltage Vopen and the battery internal resistance Rbat of the battery cell C associated with the battery temperature Tbat according to the terminal voltage Vbat, the battery temperature Tbat and the charging current or discharging current Ibat of each battery cell C, and presents the power management for each battery cell C, including SOC, the remaining battery life SOH, and the remaining usage time associated with the battery temperature Tbat. In addition, the GIC further comprises a communication module for transmitting the power management information of each battery cell C to an external battery management system.

In another embodiment, the loop switch Rsense of the GIC can be disposed externally in the charging loop or the discharging loop of the battery cell C. The GIC is provided with a control pin to control an external loop switch to temporarily cut off the charging loop or the discharging loop, so that the GIC can measure the open-loop voltage of each battery cell C.

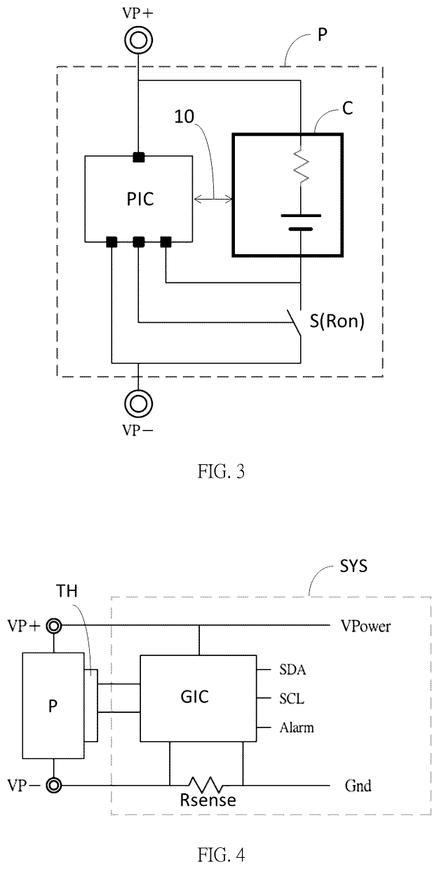

FIG. 8 illustrates a battery pack P according to yet another embodiment of the present invention. In comparison with the embodiment of FIG. 5, the battery pack P shown in FIG. 8 The chip does not include any protection integrated circuit PIC. The GIC controls the loop switch Rsense to open and measure the open-loop voltage of each battery cell C only when receiving an external signal. Because there is only one battery cell C in the battery pack P, the circuit switch Rsense cannot arbitrarily open or cut off the power supply loop in order to avoid power failure. However, the conventional protection integrated circuit PIC shown in FIG. 3 turns off the power switch S only when overtemperature or overcharge occurs. The conventional protection integrated circuit PIC cannot measure the open-loop voltage Vopen of the battery cell C.

The battery pack P of the present invention shown in FIG. 8 comprises a positive electrode terminal VP+, a negative electrode terminal VP−, a battery cell C, a GIC, a balancing resistor Rbalance and a conduction switch Ron connected in series. The battery cell C has a positive electrode and a negative electrode. The GIC includes a positive pin and a negative pin. The positive pin is electrically connected to the positive electrode of the battery cell C and the positive electrode terminal VP+, and the negative pin is electrically connected to the negative electrode of the battery cell C. The balancing resistor Rbalance is connected in series with the conducting switch Ron and is electrically connected between the positive pin and the negative pin. The loop switch Rsense is electrically connected between the negative pin and the negative electrode terminal VP−. The block diagram of the GIC and its operation are shown in FIG. 5 and the described in corresponding paragraphs.

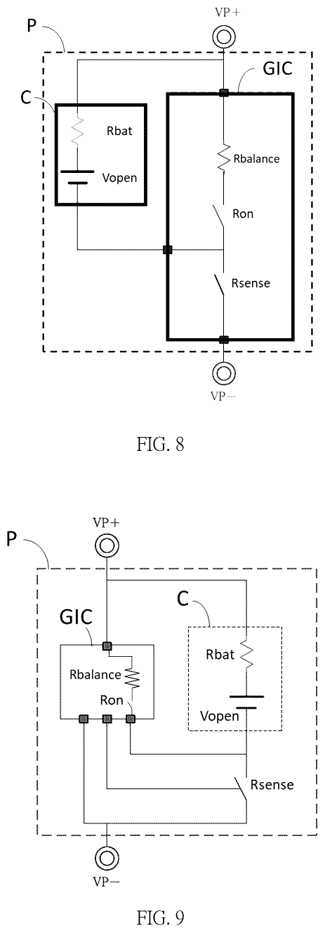

FIG. 9 shows a battery pack P according to yet another embodiment of the present invention. The GIC has a battery protection function. When the GIC detects that the battery cell C is overcharged or over discharged or has a high temperature, the GIC controls the loop switch Rsense to open via a control pin to cut off the charging loop or the discharging loop of the battery cell C. In addition, the GIC controls the loop switch Rsense to open to measure the open-loop voltage of each battery cell C and defines the SOC of the battery cell C accordingly only when receiving an external signal.

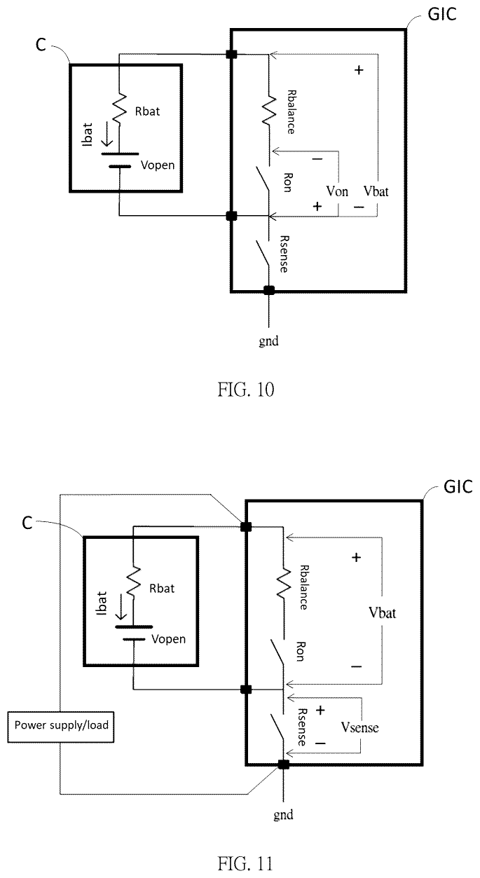

FIG. 10 shows a configuration diagram of a battery pack of the present invention, wherein when the Ron switch is turned on and the Rsense switch is turned off, the GIC can measure the terminal voltage Vbat of the battery cell and the terminal voltage Von of the Ron switch.

The invention discloses a method for calculating a battery internal resistance Rbat, implemented by a battery management integrated circuit GIC with a battery pack P of the present invention electrically connected to a power or a load. The GIC comprises a balancing resistor Rbalance, a conduction switch Ron connected to Rbalance in series and a loop switch Rsense. The Rbalance is connected in series with the conduction switch Ron and is connected in parallel to at least one battery cell C or a plurality of battery cells C connected in series. The Rsense is arranged in a charging loop or a discharging loop of the at least one battery cell C or the plurality of battery cells C connected in series. The method for calculating the battery internal resistance Rbat of the present invention comprises controlling, by the GIC, the loop switch Rsense to cut off the charging loop or the discharging loop of the battery cell C, and controlling time period where the Ron is opened in order to measure each open-loop voltage Vopen (Vbat=Vopen) of the at least one battery cell C or the plurality of battery cells C in series. Afterwards, the GIC controls the Rsense to cut off the charging loop or the discharging loop of the battery cell C and controls conduction period of the Ron, so that the GIC synchronously measures each battery terminal voltage Vbat and the battery current Ibat of the at least one battery cell C or the plurality of battery cells C in series, where the battery current Ibat=Von/Ron, and Ron is the on-resistance of the conduction switch Ron. The GIC calculates the battery internal resistance Rbat of each battery cell C according to the open-loop voltage Vopen, the battery terminal voltage Vbat and the battery current Ibat of each battery cell C. The specific formula is Rbat=(Vbat− Vopen)/Ibat.

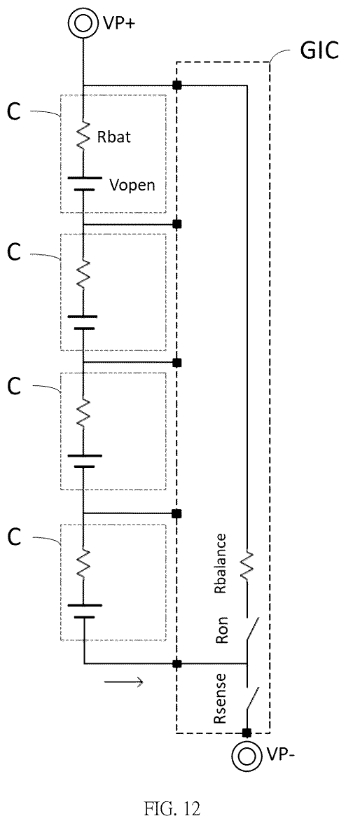

FIG. 11 is a configuration diagram of a battery pack of the present invention, wherein when the Ron switch is cut off and the Rsense switch is turned on, the battery management integrated circuit can measure the terminal voltage Vbat of the battery cell and the terminal voltage Vsense of the Rsense switch.

The invention discloses another method for calculating a battery internal resistance Rbat, implemented by a battery management integrated circuit GIC with a battery pack electrically connected to a power or a load. The GIC comprises a balancing resistor Rbalance, a conduction switch Ron connected to the Rbalance in series and a loop switch Rsense. The resistor Rbalance and the switch Ron are used to be connected in parallel to at least one battery cell C or a plurality of battery cells C connected in series. The loop switch Rsense is arranged in a charging loop or a discharging loop of the at least one battery cell C or the plurality of battery cells C connected in series. The method for calculating the battery internal resistance Rbat of the present invention comprises controlling, by the GIC, the loop switch Rsense to be turned on to form a charging loop or a discharging loop of the battery cell C, and controlling the conduction switch Ron to be turned off, so that the GIC synchronously measures twice each battery terminal voltage Vbat and battery current Ibat of the at least one battery cell C or the plurality of battery cells C in series, wherein the battery current Ibat=Vsense/Rsense, and Rsense is the on-resistance of the loop switch Rsense. According to the battery terminal voltage Vbat and the battery current Ibat measured twice for each battery cell C, the battery internal resistance Rbat of each battery cell C is calculated. The specific calculation is to combine the equation “Vbat1=Vopen−(Vsense1/Rsense)*Rbat” obtained from the first time measurement and the equation “Vbat2=Vopen−(Vsense2/Rsense)*Rbat” obtained from the second time measurement into simultaneous equations and solve the open-loop voltage Vopen and the battery internal resistance Rbat.

FIG. 12 shows a configuration diagram of a battery pack having battery cells connected in series according to the present invention.

FIG. 12 illustrates a battery pack of the present invention, which comprises a positive electrode terminal VP+ and a negative electrode terminal VP−, a plurality of battery cells C as well as a battery management integrated circuit GIC. The plurality of battery cells C connected in series. The GIC comprises a positive pin, a negative pin and at least one intermediate pin, a resistor Rbalance and a Ron switch connected in series as well as an Rsense switch. The positive pin electrically connected to a positive electrode of the battery cell C connected in series and the positive electrode terminal VP+, the intermediate pin electrically connected to the positive electrode or a negative electrode between two adjacent battery cells C connected in series, the negative pin electrically connected to the negative electrode of the battery cell C connected in series. The resistor Rbalance and a Ron switch connected in series, electrically connected between the positive pin and the negative pin. The Rsense switch, electrically connected between the negative pin and the negative electrode terminal.

The block diagram of the GIC and its operation are shown in FIG. 5 and described in the corresponding paragraph. The MCU controls the loop switch Rsense to cut off the charging current or discharging current of the series-connected battery cells C, so that the GIC measures the open-loop voltage Vopen of each battery cell C and defines the SOC of each battery cell accordingly. In addition, the MCU controls the loop switch Rsense to cut off the charging current or discharging current of the series-connected battery cell C, so that the GIC synchronously measures the open-loop voltage Vopen and the battery temperature Tbat of each battery cell C, and thereby presents the power management of each battery cell C associated with the battery temperature Tbat.

In another embodiment, the loop switch Rsense of the GIC can be externally arranged in the charging loop or the discharging loop of the battery cells C connected in series. The GIC is provided with a control pin to control an external loop switch to temporarily cut off the charging loop or the discharging loop, so that the GIC can measure the open-loop voltage Vopen of each battery cell C. The control pin is electrically connected to the loop switch Rsense to control the loop switch Rsense to disconnect the charging current or discharging current of the series-connected battery cells C, so that the GIC measures the open-loop voltage Vopen of each battery cell C and defines the state of charge SOC of each battery cell C accordingly.

FIG. 13 shows a battery pack P of the present invention in the form of parallel batteries. A battery management integrated circuit GIC of the present invention connects two battery cells C1 and C2 in parallel respectively, and controls two loop switches Rsense1 and Rsense2 to connect the two battery cells C1 and C2 in parallel, and performs charging or discharging between the positive electrode terminal VP+ and the negative electrode terminal VP−. When one of the loop switches temporarily cuts off the charging or discharging loop, the GIC can measure the open-loop voltage of one of its battery cells, and the other battery cell can continue to charge or discharge between the positive electrode terminal VP+ and the negative electrode terminal VP−. Because the battery pack P of the present invention comprises parallel-connected battery cells C1 and C2, the GIC does not need to control when the two loop switches Rsense1 and Rsense2 cut off the charging loop or the discharging loop based on external signals. Instead, the GIC autonomously controls one of the loop switches to temporarily cut off the charging loop or discharging loop of one of the battery cells, and allows the other battery cell to continue to charge or discharge.

FIG. 13 illustrates a battery pack P which comprises a positive electrode terminal VP+ and a negative electrode terminal VP−, a first battery cell C1, a second battery cell C2, and a battery management integrated circuit GIC. The first battery cell C1 has a first positive electrode and a first negative electrode. The GIC comprises a positive pin, a first negative pin and a second negative pin, a first balancing resistor Rbalance1 and a first conduction switch Ron1 connected in series, a second balancing resistor Rbalance2 and a second conduction switch Ron2 connected in series, a first loop switch Rsense1, and a second loop switch Rsense2. The positive pin is electrically connected to the first positive electrode, the second positive electrode and the positive electrode terminal VP+, the first negative pin is electrically connected to the first negative electrode of the first battery cell C1, and the second negative pin is electrically connected to the second negative electrode of the second battery cell C2. The first balancing resistor Rbalance1 and the first conducting switch Ron1 are electrically connected between the positive pin and the first negative pin. The second balancing resistor Rbalance2 and the second conducting switch Ron2 are electrically connected between the positive pin and the second negative pin. The first loop switch Rsense1 is electrically connected between the first negative pin and the negative electrode terminal VP−. The second loop switch Rsense2 is electrically connected between the second negative pin and the negative electrode terminal VP−.

During the period when the first loop switch Rsense1 and the second loop switch Rsense2 are controlled to cut off the charging loop or discharging loop of the first battery cell C1 and the second battery cell C2 respectively, the GIC measures the open-loop voltages Vopen1 and Vopen2 of the first and second battery cells C1 and C2 respectively, and defines SOC for the first and second battery cells C1 and C2 accordingly.

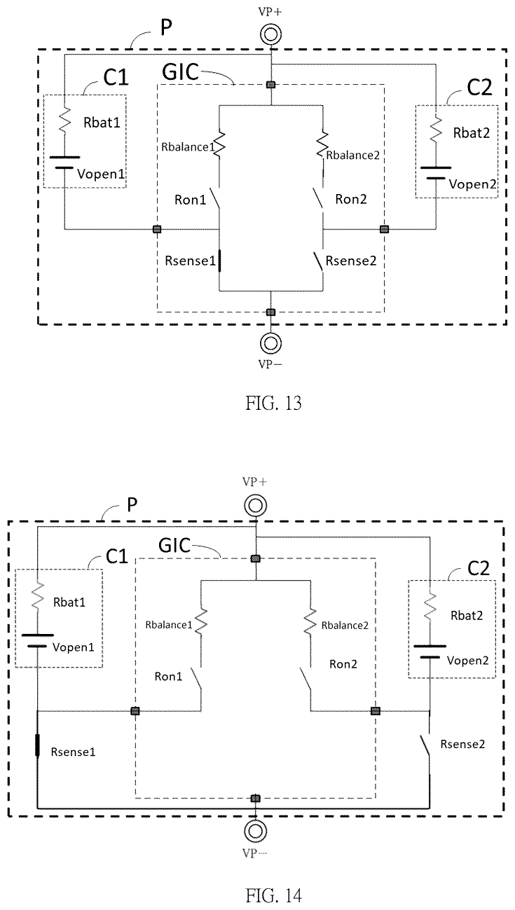

FIG. 14 shows another battery pack P of the present invention having parallel-connected batteries. Wherein, the difference between the embodiments shown in FIG. 13 and FIG. 14 is that the GIC of the present invention and the two battery cells C1 and C2 are connected in parallel between the positive electrode terminal VP+ and the negative electrode terminal VP−, and the two loop switches Rsense1 and Rsense2 are arranged outside the GIC of the present invention, respectively in the charging loop or the discharging loop of the two battery cells C1 and C2. The GIC controls two loop switches Rsense1 and Rsense2 via two control pins to cut off the charging current or discharging current of the two battery cells respectively, so that the GIC measures the open-loop voltage of the two battery cells C1 and C2 respectively. Similarly, the GIC does not need to control when the two circuit switches Rsense1 and Rsense2 cut off the charging loop or the discharging loop based on external signals. Instead, the GIC autonomously controls one of the loop switches to temporarily cut off the charging loop or discharging loop of one of the battery cells, and allows the other battery cell to continue charging or discharging.

The first loop switch Rsense1 and the second loop switch Rsense2 are controlled to cut off the charging current or discharging current of the first battery cell C1 and the second battery cell C2 respectively, so that the GIC measures the open-loop voltages Vopen1 and Vopen2 of the first and second battery cells C1 and C2 respectively, and defines SOC for the first and second battery cells C1 and C2 accordingly.

Preferably, respective loops of the two individual battery cells C1 and C2 connected in parallel, one of which is opened at a time to prevent both battery cells from being simultaneously opened and cause a power supply interruption. The battery pack P can further comprise a protection circuit, a MOSFET component and a temperature detection component for battery cell.

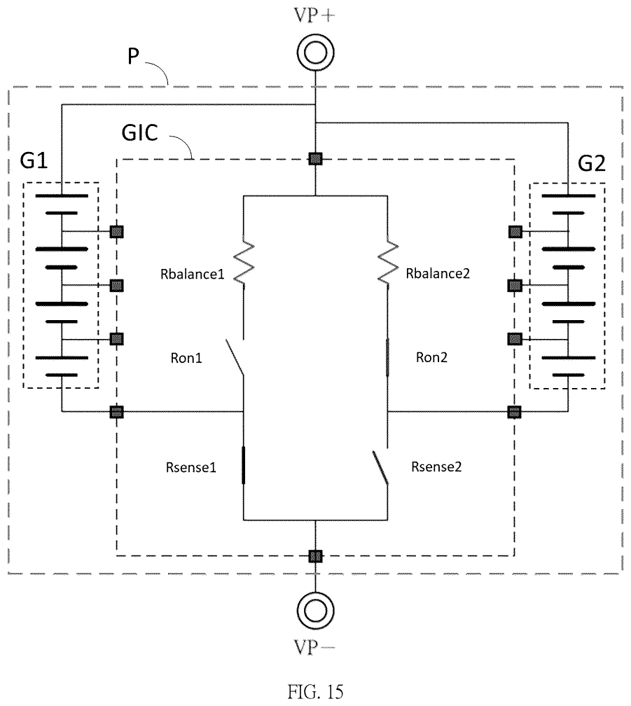

FIG. 15 shows a battery pack P having parallel-connected battery groups according to the present invention. The difference compared to the embodiment shown in FIG. 13 is that the positive electrode terminal VP+ and the negative electrode terminal VP− of the battery pack P are powered by two parallel battery groups G1 and G2, and each battery cell of the two battery groups G1 and G2 is connected in parallel to the GIC of the present invention. When one of the loop switches temporarily cuts off the charging or discharging loop, the GIC can measure the open-loop voltage of each battery cell of one battery pack, and the other battery pack can continue to charge or discharge between the positive electrode terminal VP+ and the negative electrode terminal VP−. The GIC does not need to control when the two circuit switches Rsense1 and Rsense2 cut off the charging loop or the discharging loop based on external signals. Instead, the GIC autonomously controls one of the loop switches to temporarily cut off the charging loop or discharging loop of one of the battery packs, and allows the other battery pack to continue charging or discharging.

FIG. 15 illustrates a battery pack P which comprises a positive electrode terminal VP+ and a negative electrode terminal VP−, a first battery group G1, a second battery group G2, and a battery management integrated circuit GIC. The first battery group G1 is consisted of a plurality of battery cells connected in series with a first positive electrode and a first negative electrode. The second battery group is consisted of a plurality of battery cells connected in series with a second positive electrode and a second negative electrode. The GIC comprises a positive pin, at least one first middle pin, at least one second middle pin, a first negative pin and a second negative pin, a first balancing resistor Rbalance1 and a first conduction switch Ron1 connected in series, a second balancing resistor Rbalance2 and a second conduction switch Ron2 connected in series, a first loop switch Rsense1 as well as a second loop switch Rsense2. The positive pin is electrically connected to the first positive electrode, the second positive electrode and the positive electrode terminal VP+. The first middle pin is electrically connected to the positive electrode or the negative electrode between two adjacent battery cells connected in series in the first battery group G1. The first negative pin is electrically connected to the first negative electrode of the first battery group. The second middle pin is electrically connected to the positive electrode or the negative electrode between two adjacent battery cells connected in series in the second battery group G2. The second negative pin is electrically connected to the second negative electrode of the second battery group G2. The first balancing resistor Rbalance1 and the first conduction switch Ron1 are electrically connected between the positive pin and the first negative pin. The second balancing resistor Rbalance2 and the second conduction resistor Ron2 are electrically connected between the positive pin and the second negative pin. The first loop switch Rsense1 is electrically connected between the first negative pin and the negative electrode terminal. The second loop switch Rsense2 is electrically connected between the second negative pin and the negative electrode terminal.

During the period when the first loop switch Rsense1 and the second loop switch Rsense2 are controlled to cut off the charging current or discharging current of the first battery group G1 and the second battery group G2 respectively, the GIC measures the open-loop voltage Vopen of each battery cell of the first and second battery groups G1 and G2, and defines SOC for each battery cell of the first and second battery groups G1 and G2 accordingly.

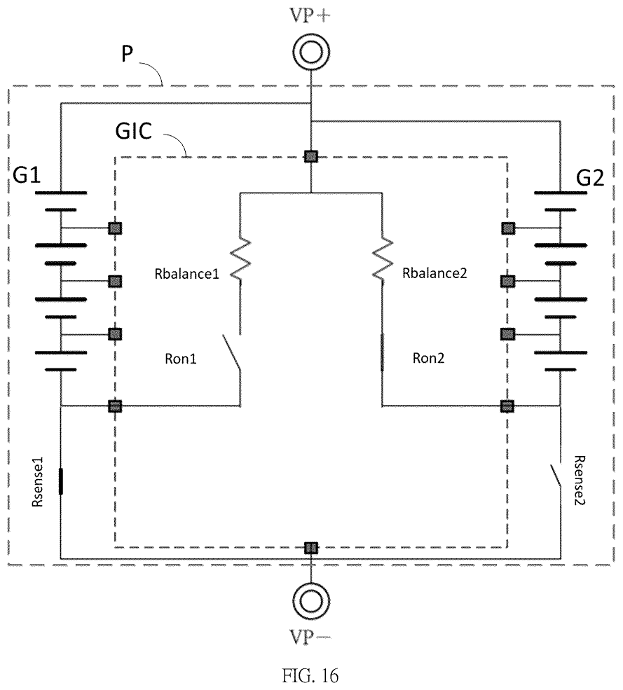

FIG. 16 shows another battery pack having parallel-connected battery groups according to the present invention. The difference compared to the embodiment shown in FIG. 15 is that the GIC of the present invention and the two battery groups G1 and G2 are connected in parallel between the positive electrode terminal VP+ and the negative electrode terminal VP−, and the two loop switches Rsense1 and Rsense2 are arranged outside the GIC of the present invention respectively in the charging loop or the discharging loop of the two battery groups G1 and G2. The GIC controls the two loop switches Rsense1 and Rsense2 respectively via two control pins to cut off the charging current or discharging current of the two battery groups respectively, so that the GIC measures the open-loop voltage of each battery cell of the two battery groups G1 and G2 respectively. Similarly, the GIC does not need to control when the two loop switches Rsense1 and Rsense2 cut off the charging loop or the discharging loop based on external signals. Instead, the GIC autonomously controls one of the loop switches to temporarily cut off the charging loop or discharging loop of one of the battery packs, and allows the other battery pack to continue charging or discharging.

The first loop switch Rsense1 and the second loop switch Rsense2 are controlled to cut off the charging current or discharging current of the first and second battery groups G1 and G2 respectively, so that the GIC measures the open-loop voltage Vopen of each battery cell of the first and second battery groups G1 and G2 respectively, and defines SOC for each battery cell of the first and second battery groups G1 and G2 accordingly.

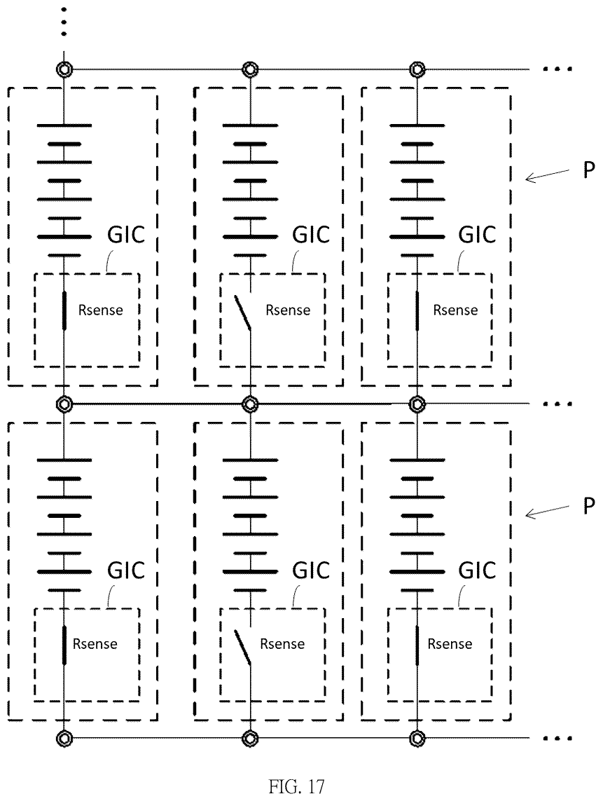

FIG. 17 shows a configuration diagram of the battery pack shown in FIG. 12 in a multi-series and multi-parallel configuration, wherein the figure does not show that each battery cell of the battery pack is connected in parallel to the battery management integrated circuit GIC of the present invention.

FIG. 17 illustrates a battery management system which comprises a plurality of battery packs P and an Rsense switch. The plurality of battery packs P are connected in a parallel-series form and configured to discharge for a terminal device or charge via the terminal device. Wherein each battery pack P comprises a plurality of battery cells and a battery management integrated circuit GIC. The battery cells are connected in a series form. The GIC comprises a plurality of polarity pins individually connected in parallel to each battery cell. The Rsense switch are connected in series to the plurality of battery cells connected in the series form. Wherein, during a charge period or a discharge period of each battery pack P, the GIC receives an external command, the external command prompts the GIC to control the Rsense switch to temporarily cut off a charge current during the charge period or a discharge current during the discharge period, and the GIC measures an open-loop terminal-voltage Vopen of each battery cell during a period in which the charge current or the discharge current is cut off and accordingly define SOC for each battery cell.

A battery management method according to the present invention comprises prompting, during a charging or discharging period of each battery cell, the battery management IC to control the Rsense switch to temporarily cut off a charge current during the charge period or a discharge current during the discharge period according to an external command, and prompting, during a period in which the charge current or the discharge current is cut off, the GIC to measure an open-loop voltage Vopen of each battery cell and accordingly define SOC for each battery cell.

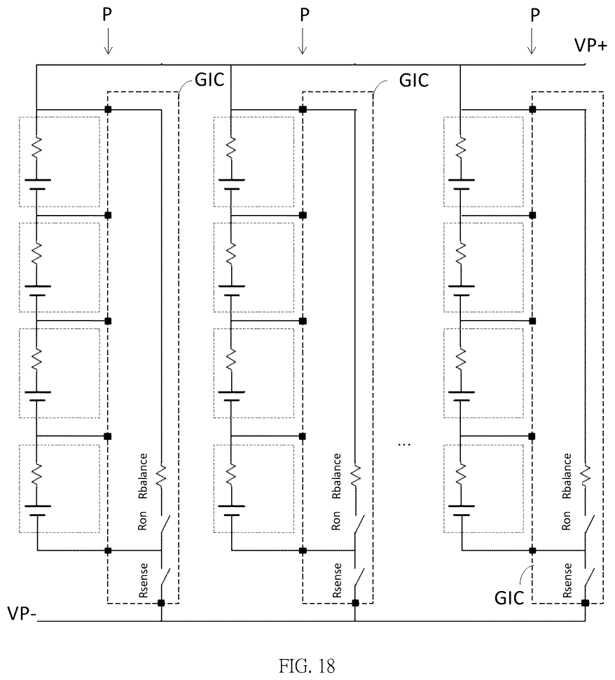

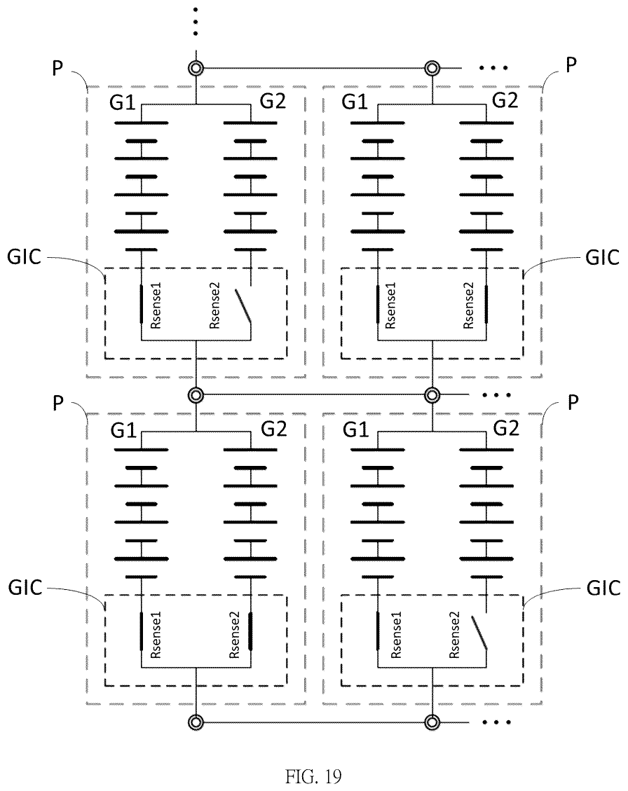

FIG. 18 shows a configuration diagram of the battery pack shown in FIG. 12 in a multi-parallel configuration, wherein the loop switch Rsense is located in the GIC and is connected between the negative electrode of the battery pack and the negative terminal VP− of the battery pack P to control the battery pack to cut off the discharge current or the charging current.

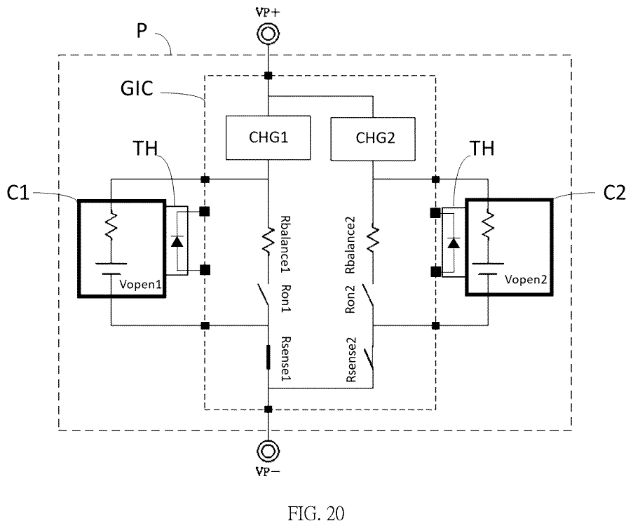

FIG. 19 shows a configuration diagram of the battery pack shown in FIG. 15 in a multi-series and multi-parallel configuration, wherein the figure does not show that each battery cell of the two battery packs is respectively connected in parallel to the GIC of the present invention. The battery management system of the present invention includes a plurality of battery packs P. The plurality of battery packs P is configured to discharge to or be charged from a terminal device in a parallel-serial manner.

In the embodiment, each battery pack P comprises a first battery group G1, a second battery group G2, and a battery management integrated circuit GIC. The first battery group G1 and the second battery group G2 are respectively composed of a plurality of battery cells connected in series. The first battery group G1 and the second battery group G2 are connected in parallel. The GIC comprises a plurality of polarity pins, a first loop switch Rsense1 and a second loop switch Rsense2. The first loop switch Rsense1 and the second loop switch Rsense2 are respectively connected in series to the first battery group G1 and the second battery group G2. During the charging or discharging period of each battery pack P, the GIC controls the first loop switch Rsense1 or the second loop switch Rsense2 to temporarily cut off a charging current or a discharging current of the first battery group G1 or the second battery group G2, and during the period of cutting off the charging current or the discharging current, the GIC measures the open-loop voltage Vopen of each battery cell of the first battery group G1 or the second battery group G2 through the polarity pins, and defines SOC for each battery cell accordingly.

FIG. 20 is a diagram showing the configuration of a battery pack having charge and discharge circuits according to the present invention.

In the embodiment, the battery pack P of the present invention comprises a positive electrode terminal VP+, a negative electrode terminal VP−, a first battery cell C1, a second battery cell C2, and a GIC. The positive electrode terminal VP+ and the negative electrode terminal VP− are used to electrically connect to an external charging and discharging power source. The first battery cell C1 has a first positive electrode and a first negative electrode. The second battery cell C2 has a second positive electrode and a second negative electrode. The GIC comprises a first positive pin, a first negative pin, a second positive pin, a second negative pin, a first balancing resistor Rbalance1 and a first conduction switch Ron1 connected in series, a second balancing resistor Rbalance2 and a second conduction switch Ron2 connected in series, a first loop switch Rsense1, a second loop switch Rsense2, a first charge and discharge circuit CHG1, and a second charge and discharge circuit CHG2. The first positive pin is electrically connected to the first positive electrode. The second positive pin is electrically connected to the second positive electrode. The first negative pin is electrically connected to the first negative electrode. The second negative pin is electrically connected to the second negative electrode. The first balancing resistor Rbalance1 is connected in series with the first conduction switch Ron1 and is electrically connected between the positive pin and the first negative pin. The second balancing resistor Rbalance2 is connected in series with the second conduction switch Ron2 and is electrically connected between the positive pin and the second negative pin. The first loop switch Rsense1 is electrically connected between the first negative pin and the negative electrode terminal. The second loop switch Rsense2 is electrically connected between the second negative pin and the negative electrode terminal. The CHG1 is electrically connected between the positive electrode terminal VP+ and the first positive pin. The CHG2 is electrically connected between the positive electrode terminal VP+ and the second positive pin. The positive electrode terminal VP+ and the negative electrode terminal VP− are used to electrically connect to an external power source or a load.

In another embodiment, the first loop switch Rsense1 and the second loop switch Rsense2 may be replaced by a first loop switch and a second loop switch located outside the GIC, respectively. The first loop switch is electrically connected between the first negative electrode and the negative electrode terminal, and the second loop switch is electrically connected between the second negative electrode and the negative electrode terminal. The GIC comprises a first control pin and a second control pin, which are electrically connected to the first loop switch and the second loop switch respectively, and are used to control the first loop switch and the second loop switch to respectively cut off the charging current or discharging current of the first battery cell C1 and the second battery cell C2, so that the GIC measures the open-loop voltages Vopen1 and Vopen2 of the first and second battery cells C1 and C2, and defines SOC of the first and second battery cells C1 and C2 accordingly.

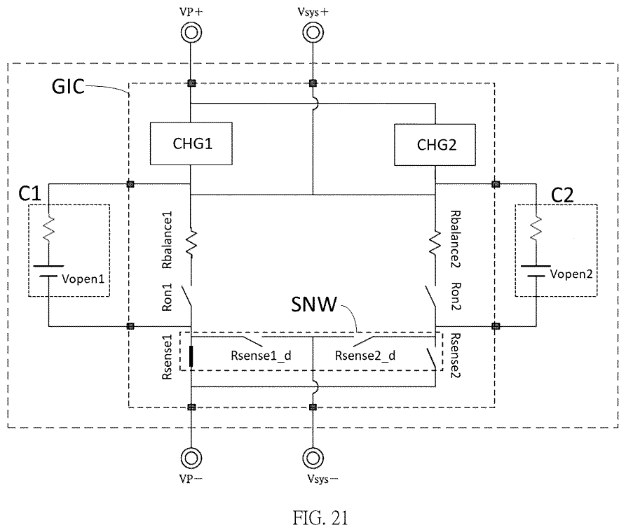

FIG. 21 illustrates a configuration diagram of another battery pack with chargers and dischargers according to the present invention. The battery pack P of the present invention can be connected to the Type-C USB port via the charging and discharging power supply terminals (VP+, VP−), and the power supply terminals (Vsys+, Vsys−) required by the system. Therefore, the present invention can completely separate the charging and discharging power source from the power source required by the system, such as power consumption by Apps.

In the embodiment, the battery pack P of the present invention comprises a first positive electrode terminal VP+, a second positive electrode terminal Vsys+, a first negative electrode terminal VP− and a second negative electrode terminal Vsys−, a first battery cell C1, a second battery cell C2, and a battery management integrated circuit GIC. The first battery cell C1 has a first positive electrode and a first negative electrode. The second battery cell C2 has a second positive electrode and a second negative electrode.

The first positive electrode terminal VP+ and the first negative electrode terminal VP− are used to electrically connect to an external charging and discharging power source. The second positive electrode terminal Vsys+ and the second negative electrode terminal Vsys− are used to electrically connect to a system consuming power.

The GIC comprises a first positive pin, a second positive pin, a first negative pin and a second negative pin, a first charge and discharge circuit CHG1, a second charge and discharge circuit CHG2, a first balancing resistor Rbalance1 and a first conduction switch Ron1 connected in series, a second balancing resistor Rbalance2 and a second conduction switch Ron2 connected in series, and a switching network SNW.

The first positive pin is electrically connected to the first positive electrode. The second positive pin is electrically connected to the second positive electrode. The first negative pin is electrically connected to the first negative electrode. The second negative pin is electrically connected to the second negative electrode. The second positive electrode terminal Vsys+ is electrically connected to the first positive pin and the second positive pin. The CHG1 is electrically connected between the first positive electrode terminal VP+ and the first positive pin. The CHG2 is electrically connected between the first positive electrode terminal VP+ and the second positive pin. The first balancing resistor Rbalance1 and the first conduction switch Ron1 are electrically connected between the positive pin and the first negative pin. The second balancing resistor Rbalance2 and the second conduction switch Ron2 are electrically connected between the positive pin and the second negative pin. The switching network SNW selectively switches the first negative electrode terminal VP− and the second negative electrode terminal Vsys− to be electrically connected to the first negative electrode and the second negative electrode, so as to selectively cut off the charging loop and the discharging loop of the first battery cell C1 and the second battery cell C2, so that the GIC measures the open-loop voltages Vopen1 and Vopen2 of the first and second battery cells C1 and C2, and defines SOC for the first and second battery cells C1 and C2 accordingly.

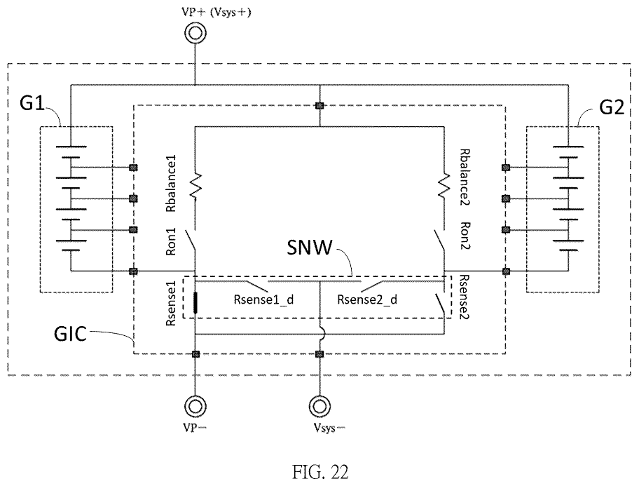

FIG. 22 shows a configuration diagram of another battery pack with a charger and discharger according to the present invention. In the embodiment, the battery pack P of the present invention comprises a positive electrode terminal VP+, a first negative electrode terminal VP−, a second negative electrode terminal Vsys−, a first battery group G1, a second battery group G2, and a battery management integrated circuit GIC.

The positive electrode terminal VP+ may also serve as the positive electrode terminal Vsys+ of the system. The positive electrode terminal VP+ and the first negative electrode terminal VP− are used to electrically connect to an external charging and discharging power source. The first positive electrode terminal VP+ and the second negative electrode terminal Vsys− are used to electrically connect the power for system. For example, in a charging application, the Type C connector may be used to electrically connect the positive electrode terminal VP+ and the first negative electrode terminal VP−. In applications of supplying power to a system, the battery pack P can provide the required power through the positive electrode terminal VP+ and the second negative electrode terminal Vsys−.

The first battery group G1 is composed of a plurality of battery cells connected in series and has a first positive electrode and a first negative electrode. The second battery group G2 is composed of a plurality of battery cells connected in series and has a second positive electrode and a second negative electrode. The GIC comprises a positive pin, at least one first intermediate pin, at least one second intermediate pin, a first negative pin and a second negative pin, a first balancing resistor Rbalance1 and a first conduction switch Ron1 connected in series, a second balancing resistor Rbalance2 and a second conduction switch Ron2 connected in series, and a switching network SNW.

The positive pin is electrically connected to the first positive electrode, the second positive electrode and the positive electrode terminal VP+. The first intermediate pin is electrically connected to the positive electrode or the negative electrode between two adjacent battery cells connected in series in the first battery group G1. The first negative pin is electrically connected to the first negative electrode of the first battery cell. The second intermediate pin is electrically connected to the positive electrode or the negative electrode between two adjacent battery cells connected in series in the second battery group G2. The second negative pin is electrically connected to the second negative electrode of the second battery cell. The first balancing resistor Rbalance1 and the first conduction switch Ron1 are electrically connected between the positive pin and the first negative pin. The second balancing resistor Rbalance2 and the second conduction switch Ron2 are electrically connected between the positive pin and the second negative pin. The switching network SNW selectively switches the first negative electrode terminal VP− and the second negative electrode terminal Vsys− to be electrically connected to the first negative electrode and the second negative electrode, so as to selectively cut off the charging path and the discharging path of the first and second battery groups G1 and G2, so that the GIC measures the open-loop voltage Vopen of each battery cell of the first and second battery groups G1 and G2, and defines SOC of each battery cell of the first and second battery groups G1 and G2 accordingly.

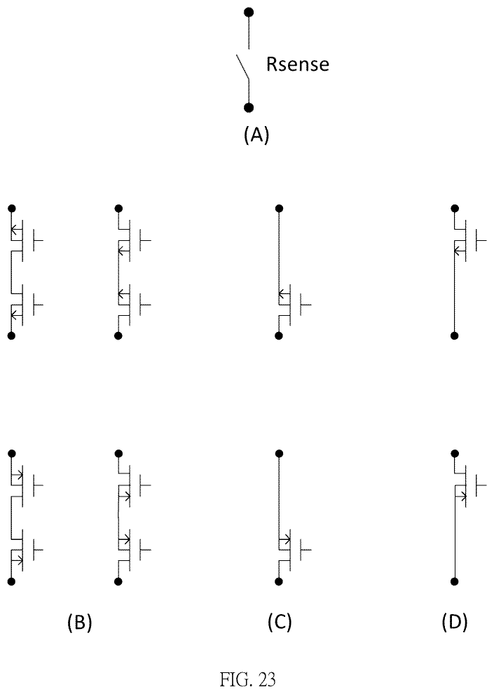

FIG. 23 illustrates multiple embodiments of the loop switch Rsense implemented by the present invention, wherein FIG. 23A illustrates the circuit component of the loop switch Rsense, FIG. 23B illustrates specific multiple MOSFET loop switches of P-type and N-type which can be opened when the battery pack is charging or discharging, FIG. 23C illustrates MOSFET loop switches of P-type and N-type which can only be opened when the battery pack is discharging, and FIG. 23D illustrates MOSFET loop switches of P-type and N-type which can only be opened when the battery pack is charging.

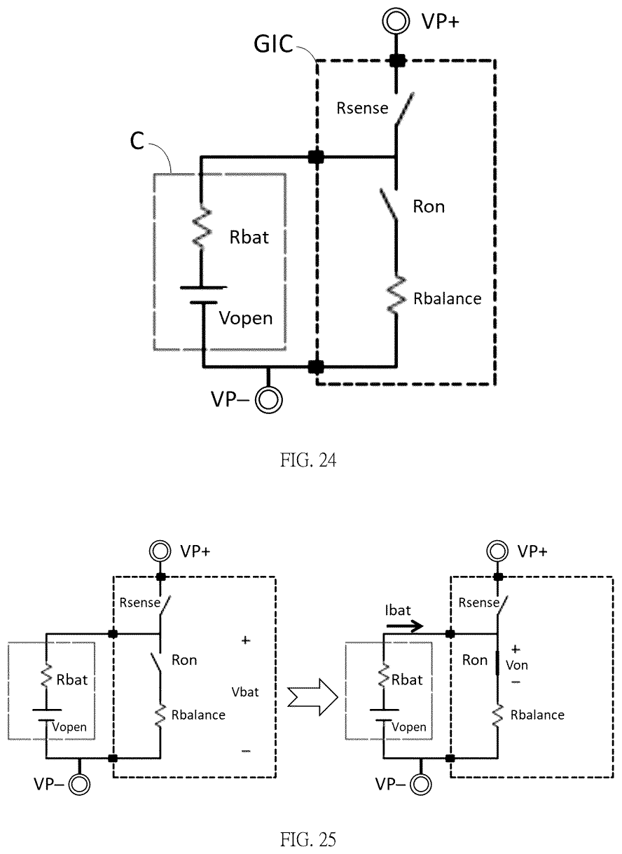

FIG. 24 illustrates another configuration diagram of the battery pack of the present invention. The GIC comprises a loop switch Rsense, a conduction switch Ron and a balancing resistor Rbalance connected in series. The series-connected conduction switch Ron and a balancing resistor Rbalance are connected in parallel to the battery cell C, and the loop switch Rsense is arranged in the charging and discharging loop between the VP+ terminal and the positive electrode of the battery cell C, and the negative electrode of the battery cell C is electrically connected to the VP− terminal. The Rsense switch can be a P-type MOSFET.

The GIC can measure the open-loop voltage Vopen of the battery cell C and the battery internal resistance Rbat by turning on and off the conduction switch Ron and the loop switch Rsense.

The balancing resistor Rbalance is provided for a discharge current Ibat measurement and limits the current Ibat within a certain range. When the conduction switch Ron is turned on and a discharge current Ibat is generated, the balancing resistor Rbalance is used to balance the open-loop voltage Vopen. The conduction switch Ron and the loop switch Rsense can be calibrated before the GIC is packaged to accurately measure the battery discharge current Ibat. The calculation manner of the open-loop voltage Vopen and the battery internal resistance Rbat is further described below.

FIG. 25 is a schematic diagram illustrating the battery pack of the present invention shown in FIG. 24 used to measure the open-loop voltage Vopen of the battery cell C and the terminal voltage Von of the Ron switch, so as to calculate the battery internal resistance Rbat.

Calculating the battery internal resistance Rbat of the present invention is implemented in the GIC. First, the loop switch Rsense is opened to disconnect the charging or discharging loop of the battery cell C and the conduction switch Ron is opened, and the GIC measures the terminal voltage Vbat of the battery cell C. At this time, the terminal voltage Vbat is equal to the open-loop voltage Vopen.

Next, after the conduction switch Ron is closed, the terminal voltage Vbat of the battery cell C and the terminal voltage Von of the conduction switch are measured again, and Ibat=Von/Ron is obtained according to the equation Von=Ibat*Ron.

Finally, the battery internal resistance Rbat is obtained according to the equation Vbat=Vopen+ (Ibat*Rbat).

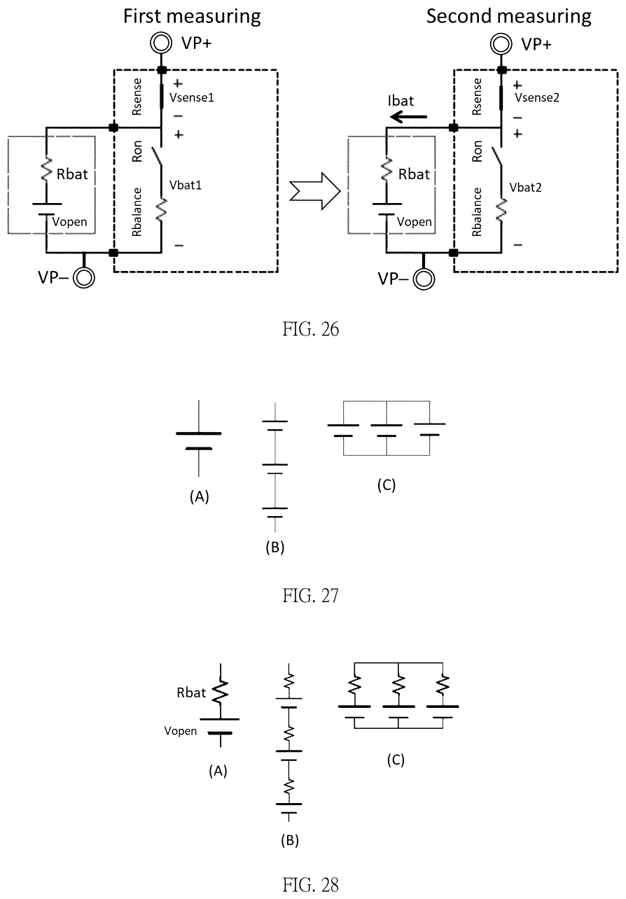

FIG. 26 illustrates the battery pack of the present invention shown in FIG. 24 being used to measure the voltage Vopen and the current Ibat of the battery cell twice to calculate the resistance Rbat.

Calculating the battery internal resistance Rbat of the present invention is implemented in the GIC. First, the conduction switch Ron is opened and the loop switch Rsense is closed.

Next, the first measurement is performed to synchronously measure the battery cell terminal voltage Vbat1 and the loop switch terminal voltage Vsense1. According to the equations Vbat1=Vopen-Ibat1*Rbat, and Vsense1=Ibat1*Rsense, we get a binary equation, Vbat1=Vopen-(Vsense1/Rsense)*Rbat.

Next, a second measurement is performed to synchronously measure the battery cell terminal voltage Vbat2 and the loop switch terminal voltage Vsense2. According to the equations, Vbat2=Vopen-Ibat2*Rbat, and Vsense2=Ibat2*Rsense, we can get a binary equation, Vbat2=Vopen-(Vsense2/Rsense)*Rbat.

Finally, the simultaneous equations are calculated to obtain the open-loop voltage Vopen and the battery internal resistance Rbat.

FIGS. 27A, 27B and 27C illustrate various configuration of battery cells of a battery pack.

As shown in FIG. 27A, a battery pack is composed of a single battery cell. As shown in FIG. 27B, a battery pack is composed of a plurality of battery cells connected in series. As shown in FIG. 27C, a battery pack is composed of a plurality of battery cells connected in parallel. The plurality of battery cells connected in series as shown in FIG. 27B may be an equivalent battery as shown in FIG. 27A, wherein the terminal voltage of the equivalent battery is the sum of the terminal voltages of the plurality of battery cells, the current of the equivalent battery is equal to the current of each battery cell, and the capacity of the equivalent battery is the product of a sum of terminal voltages and the current. The plurality of battery cells connected in parallel as shown in FIG. 27C may also be an equivalent battery as shown in FIG. 27A, wherein the terminal voltage of the equivalent battery is the terminal voltage of each battery cell, the current of the equivalent battery is equal to the sum of the currents of the plurality of battery cells, and the capacity of the equivalent battery is the product of the terminal voltage and the currents.

FIGS. 28A, 28B and 28C respectively illustrate the equivalent circuits of the battery cells shown in FIGS. 27A, 27B and 27C.

As shown in FIG. 28A, it is the equivalent circuit of a single battery cell. FIG. 28B illustrates an equivalent circuit of a plurality of battery cells connected in series. As shown in FIG. 28C, this is an equivalent circuit of multiple battery cells connected in parallel. The equivalent open-loop voltage and the equivalent battery internal resistance of the equivalent circuit shown in FIG. 28B are respectively a sum of the individual open-loop voltages Vopen and a sum of the individual battery internal resistances Rbat of the battery cells connected in series. The battery internal resistance of the equivalent circuit can be used to evaluate the capacity limit of battery cells connected in series. The equivalent open-loop voltage and the equivalent battery internal resistance of the equivalent circuit shown in FIG. 28C are the individual open-loop voltage Vopen of the parallel-connected battery cells and the parallel connection of the battery internal resistances Rbat. The battery internal resistance of the equivalent circuit can be used to evaluate the quality of the battery cells connected in parallel.

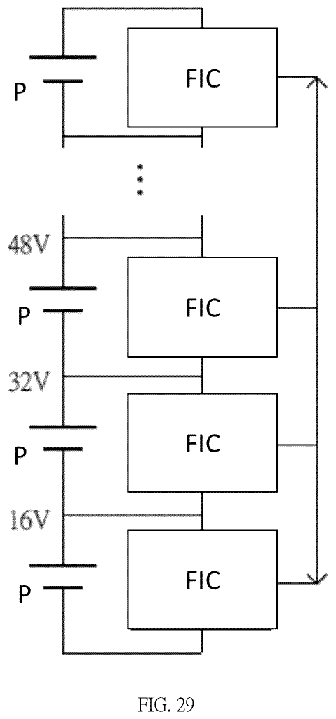

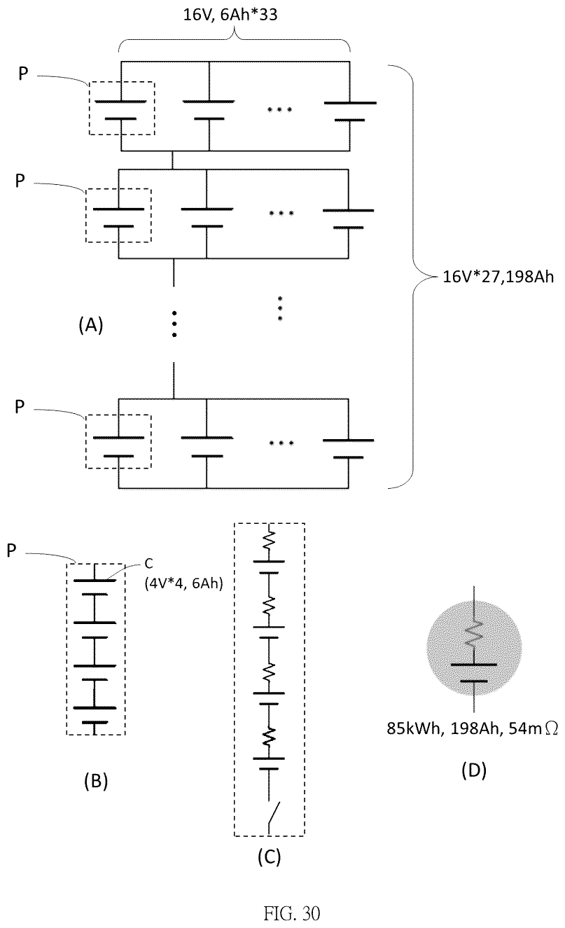

FIG. 29 shows a circuit diagram of a plurality of battery packs connected in series, wherein each battery pack is connected in parallel to a functional integrated circuit (FIC), and there is at least one synchronous control pin between the functional integrated circuits. The functional integrated circuit is used to balance the charge between battery packs connected in series, so that the charging or discharging performance of all battery cells in the series battery pack remains at a consistent level. In addition to being connected in parallel to the corresponding battery pack P, the functional integrated circuit FIC is also electrically connected to other functional integrated circuit FIC connected in parallel to the adjacent battery pack P to receive synchronization control signals from the other functional integrated circuits FIC or send synchronization control signals to the other functional integrated circuits FIC.

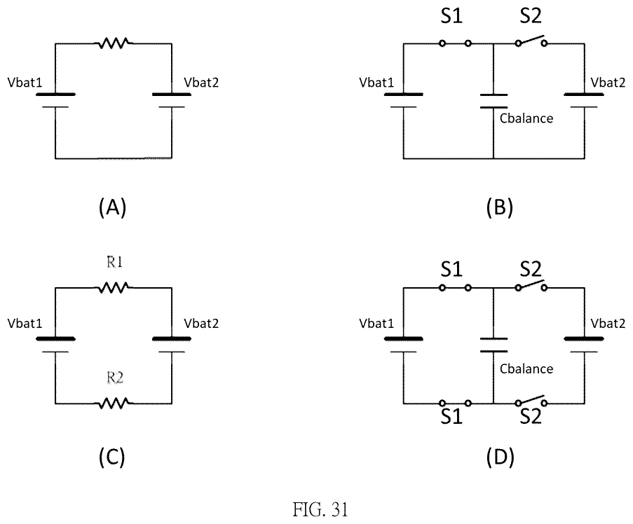

FIGS. 30A, B, C and D illustrate the configuration of a power battery and its equivalent circuit diagram.

Taking power battery used in electric vehicles as an example, as shown in FIG. 30B, each battery cell C has an internal resistance of 16.5 mΩ and supplies 4V voltage and 6 Ah of power. Four battery cells C connected in series form a battery pack P with an internal resistance of 66 mΩ. The battery pack P provides 16V voltage and 6 Ah of power and its charging and discharging circuit is controlled by a loop switch. The equivalent circuit of the battery pack P is shown in FIG. 30C. Next, the 33 battery packs P connected in parallel have an internal resistance of 2 mΩ and can provide a voltage of 16V and a capacity of 198 Ah. Finally, 27 battery packs connected in series and 33 battery packs connected in parallel form a power battery assembly, which has an internal resistance of 54 mΩ and can provide 432 V voltage and 198 Ah power. FIG. 30D illustrates the equivalent circuit of the power battery assembly, which can supply a total power of approximately 85 KWh, a capacity of 198 Ah, and an equivalent internal resistance of 54 mΩ. However, once there are quality differences among numerous battery cells, each battery pack P will have a series balancing issue in charging and discharging, and the parallel-connected battery packs of the power battery will have a balancing issue in charging and discharging.

FIGS. 31A, B, C and D illustrate various circuit diagrams for balancing.

FIG. 31A illustrates a common ground passive voltage balancing circuit. As shown in FIG. 31B, a common-ground capacitor active voltage balancing circuit has an equivalent resistance of 1/(f*C), where f is a non-overlapping control signal frequency for the switch S1 and the switch S2, and Cbalance is the balancing capacitance. FIG. 30C illustrates an example of a non-common ground passive voltage balancing circuit. As shown in FIG. 30D, a non-common ground capacitor active voltage balancing circuit has an equivalent resistance of 1/(f*C), where f is a non-overlapping control signal frequency for the switch S1 and the switch S2, and Cbalance is the balancing capacitance.

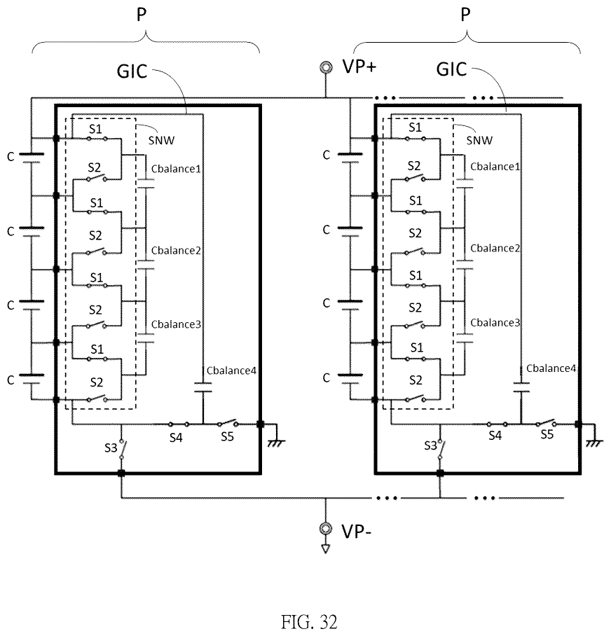

FIG. 32 shows battery packs of the present invention in a parallel configuration, wherein the GIC further comprises a series balancing circuit and a parallel balancing circuit for a voltage balancing function.

As shown in FIG. 32, the series balancing circuit, for a small unit battery, of the GIC is used to balance the series-connected battery cells in the battery pack. The series balancing function of the four battery cells is mainly accomplished by a switching network SNW composed of a plurality of first switches S1 and a plurality of second switches S2, and three series balancing capacitors Cbalance1, Cbalance2 and Cbalance3. Each series balancing capacitor can complete power transfer between adjacent battery cells C through the operation of the switching network SNW.

A fourth switch S4 is controlled to connect a parallel balancing capacitor Cbalance4 to the series-connected battery cells connected in parallel, and cooperates with a fifth switch S5 to complete the parallel balancing function between the parallel-connected battery packs, wherein each GIC has a common ground pin, and the common ground pins are electrically connected to each other. A third switch S3 is connected to the charging loop and the discharging loop of the battery cells, and is connected between a negative electrode of the battery series and a negative terminal VP− of the battery pack as shown in the figure to control the opening and closing of the loops. Whether the third switch S3 is opened or closed does not affect the balancing operation performed among the four battery cells.

As shown in FIG. 32, the GIC of the present invention is used to parallel balance a plurality of parallel-connected battery packs and to series balance a plurality of series-connected battery cells to discharge a terminal device or to get charged from the terminal device.

The battery management system of the present invention is used for parallel balancing of a plurality of battery packs P connected in parallel and for series balancing of a plurality of battery cells C connected in series, so as to discharge a terminal device or be charged from the terminal device. Each battery pack P comprises a plurality of battery cells C connected in series and a battery management integrated circuit GIC, wherein each battery cell C is connected to the GIC. The GIC comprises a plurality of pins, a switching network SNW, a plurality of series balancing capacitors Cbalance1 to Cbalance3, a parallel balancing capacitor Cbalance4, and a common pin.

The plurality of pins are used to connect each battery cell C in parallel. Each of the plurality of series balancing capacitors (i.e. Cbalance1, Cbalance2, and Cbalance3) is used to balance two adjacent battery cells C. The switching network SNW electrically connects the plurality of pins and the plurality of series balancing capacitors to switch the pins between adjacent battery cells C to be electrically connected to corresponding series balancing capacitors. The parallel balancing capacitor Cbalance4 is used to be selectively connected in parallel to the plurality of battery cells C connected in series. The common pin is selectively electrically connected to the balancing capacitor Cbalance4.

The GIC further comprises a first switch S1, which can selectively open the charging loop or the discharging loop of the plurality of battery cells C and determine the timing when the plurality of battery cells C of the battery pack P is connected in parallel to other battery packs P. According to the battery management system of the present invention, terminal device manufacturers can quickly and safely assemble a high-power battery. By electrically connecting the common pins of the battery management integrated circuit, the added battery pack can get balanced at first when connected in parallel to the high-power battery, reducing the difference between the highest and lowest battery voltages, avoiding the loss of battery internal resistance, and at the appropriate time, the third switch S3 determines when the added battery pack is connected in parallel to other battery packs.

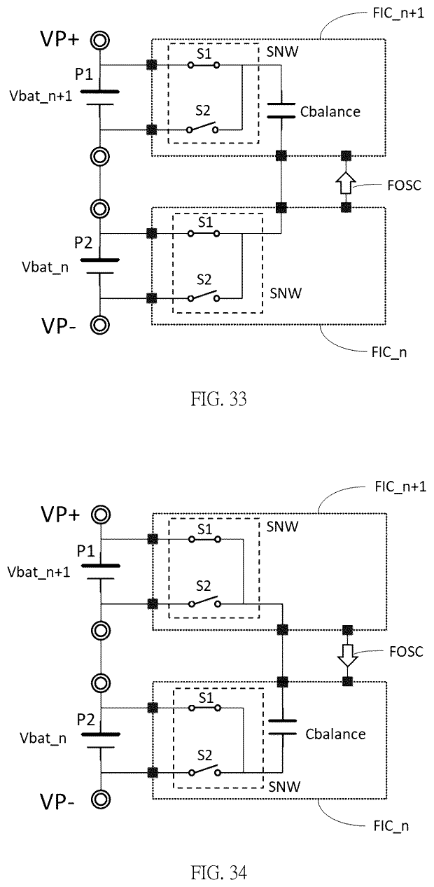

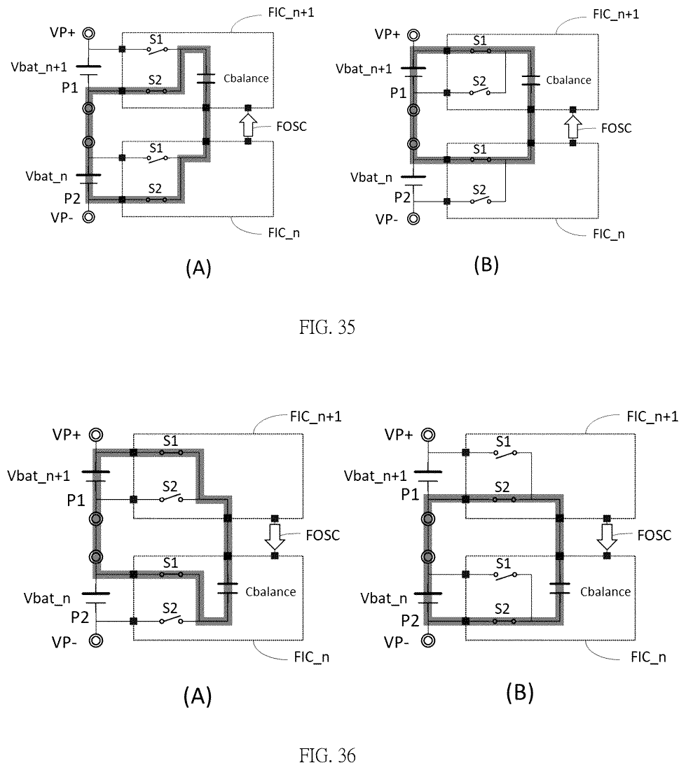

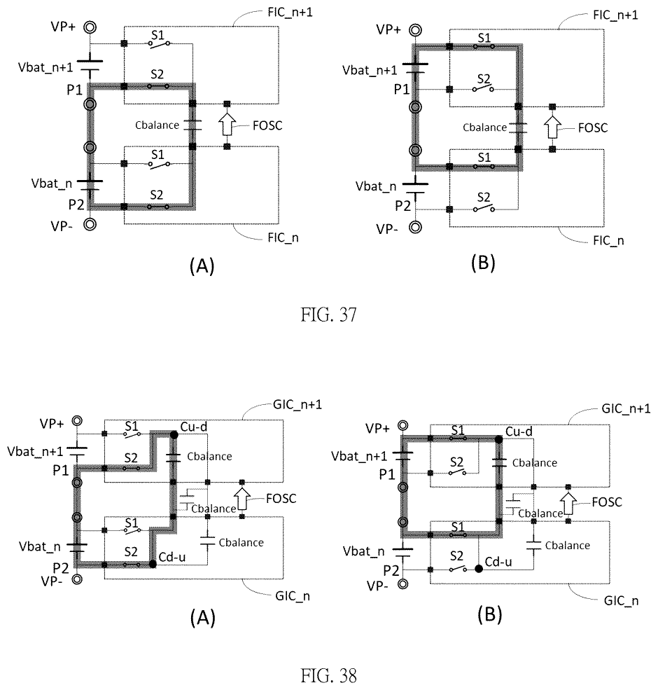

The invention discloses a battery management system which implements a series balancing circuit for battery packs. In an embodiment of the present invention, a battery management system comprises a plurality of battery packs connected in series and a plurality of functional integrated circuits FIC. The adjacent functional integrated circuits FIC cooperate to implement a series balancing circuit for the battery packs to balance the power of the battery packs connected in series. Each battery pack comprises a battery group G composed of a plurality of battery cells C, and each battery pack is connected in parallel to a functional integrated circuit FIC. With synchronous control among the functional integrated circuits FIC, a high-power series balancing function is completed between adjacent battery packs P. The functional integrated circuit FIC of the present invention comprises at least one synchronous control pin, at least one balancing pin and a switching network SNW, wherein the synchronous control pin FOSC is electrically connected to the other synchronous control pin of the adjacent functional integrated circuit FIC to instruct the battery pack with higher terminal voltage to balance the battery pack with lower terminal voltage. The balance pin is electrically connected to the other balance pin of the adjacent functional integrated circuit FIC to establish a power balance loop of the adjacent functional integrated circuit FIC. At least one balancing capacitor Cbalance for balancing the charge can be arranged inside the functional integrated circuit FIC, as shown in the embodiments of FIGS. 33 and 34, or arranged between the balancing pins of adjacent functional integrated circuits FIC, as shown in the embodiments of FIGS. 37 and 38.

The series balancing function for battery packs refers to the power balance between battery packs connected in series. As shown in FIG. 33, the voltage between the equivalent battery terminal voltages Vbat_n and Vbat_n+1 of two battery packs connected in series is balanced, and the synchronous control pins FOSC and the balance pins of the functional integrated circuits FIC_n+1 and FIC_n are electrically connected respectively. In one embodiment of the present invention, when the terminal voltage Vbat_n is greater than the terminal voltage Vbat_n+1 by more than a preset value, the battery management system of the present invention activates a corresponding action to enable at least one functional integrated circuit FIC to implement the power balance (namely upper-to-lower power balance) of the battery pack P2 to battery pack P1 according to the sending direction of the control signal FOSC. To simplify the complexity of FIG. 33, the functional integrated circuits FIC_n+1 and FIC_n only illustrate the power balancing circuit of the switching network SNW portion, and the balancing capacitor Cbalance is arranged inside the functional integrated circuit FIC_n+1. According to the sending direction of the control signal FOSC, the two switching networks SNW implement lower-to-upper power balancing. First, the two switches S2 are closed and the two switches S1 are opened to establish the power balancing loop shown in FIG. 35A to balance the power of the battery pack P2 and the balancing capacitor Cbalance (storing energy). Next, the two switches S2 are opened and the two switches S1 are closed to establish the power balancing loop shown in FIG. 35B to balance the power of the battery pack P1 and the balancing capacitor Cbalance (releasing energy). In another embodiment of the present invention, when the terminal voltage Vbat_n+1 is greater than the terminal voltage Vbat_n by more than a preset value, the battery management system of the present invention activates a corresponding action to enable at least one functional integrated circuit FIC to implement the power balance (namely upper-to-lower power balance) of the battery pack P1 to battery pack P2 according to the sending direction of the control signal FOSC, such as the opposite direction of FOSC shown in FIGS. 33 and 35. The two switching networks SNW implement upper-to-lower power balancing. First, the power balancing loop shown in FIG. 35B is established to balance the power of the battery pack P1 and the balancing capacitor Cbalance (storing energy). Then, the power balancing loop shown in FIG. 35A is established to balance the power of the battery pack P2 and the balancing capacitor Cbalance (releasing energy).

As another embodiment shown in FIG. 34, the equivalent battery terminal voltages Vbat_n and Vbat_n+1 of two battery packs connected in series are balanced, and the synchronous control pins FOSC and the balance pins of the functional integrated circuits FIC_n+1 and FIC_n are electrically connected respectively. In one embodiment of the present invention, when the terminal voltage Vbat_n+1 is greater than the terminal voltage Vbat_n by more than a preset value, the battery management system of the present invention activates a corresponding action to enable at least one functional integrated circuit FIC to implement the power balance (namely upper-to-lower power balance) of the battery pack P1 to battery pack P2 according to the sending direction of the control signal FOSC. To simplify the complexity of FIG. 34, the functional integrated circuits FIC_n+1 and FIC_n only illustrate the power balancing circuit of the switching network SNW portion, and the balancing capacitor Cbalance is arranged inside the functional integrated circuit FIC_n. According to the sending direction of the control signal FOSC, the two switching networks SNW implement upper-to-lower power balancing. First, the two switches S1 are closed and the two switches S2 are opened to establish the power balancing loop shown in FIG. 36A to balance the power of the battery pack P1 and the balancing capacitor Cbalance (storing energy). Next, the two switches S1 are opened and the two switches S2 are closed to establish the power balancing loop shown in FIG. 36B to balance the power of the battery pack P2 and the balancing capacitor Cbalance (releasing energy). In another embodiment of the present invention, when the terminal voltage Vbat_n is greater than the terminal voltage Vbat_n+1 by more than a preset value, the battery management system of the present invention activates a corresponding action to enable at least one functional integrated circuit FIC to implement the power balance (namely lower-to-upper power balance) of the battery pack P2 to battery pack P1 according to the sending direction of the control signal FOSC, such as the opposite direction of FOSC shown in FIGS. 34 and 36. The two switching networks SNW implement lower-to-upper power balancing. First, the power balancing loop shown in FIG. 36B is established to balance the power of the battery pack P2 and the balancing capacitor Cbalance (storing energy), and then the power balancing loop shown in FIG. 36A is established to balance the power of the battery pack P1 and the balancing capacitor Cbalance (releasing energy).

According to the embodiments shown in FIG. 33 and FIG. 34, the present invention achieves a voltage series balancing between two battery packs through the coordinated operation of two functional integrated circuits FIC and the arrangement of the balancing capacitor Cbalance. The balancing capacitor Cbalance may be arranged in the functional integrated circuit FIC_n+1 or in the functional integrated circuit FIC_n. Those skilled in the art of the invention can also easily arrange balancing capacitors in both the two-functional integrated circuits FIC_n+1 and FIC_n, as shown in FIG. 38, to increase the capacity of the balancing capacitors. The switches S1 and S2 of the two functional integrated circuits FIC_n+1 and FIC_n must be non-overlap switches that operate synchronously. The sending direction of the control signal FOSC between the two functional integrated circuits FIC can be transmitted from FIC_n+1 to FIC_n, or from FIC_n to FIC_n+1, so as to synchronously control the operations of the switches S1 and the switches S2.

FIGS. 37A and 37B show a power balancing circuit diagram of another embodiment of the battery management system of the present invention for implementing high-power series balancing management. Compared with the embodiments shown in FIGS. 33 and 34, the arrangement of the balancing capacitor Cbalance is electrically connected between the balancing pins of the functional integrated circuit FIC_n+1 and the balancing pin of FIC_n.

In one embodiment of the present invention, when the terminal voltage Vbat_n is greater than the terminal voltage Vbat_n+1 by more than a preset value, the battery management system of the present invention activates a corresponding action to enable at least one functional integrated circuit FIC to implement the power balance (namely lower-to-upper power balance) of the battery pack P2 to battery pack P1 according to the sending direction of the control signal FOSC. To simplify the complexity of FIG. 37, the functional integrated circuits FIC_n+1 and FIC_n only illustrate the power balancing circuit of the switching network SNW portion, and the balancing capacitor Cbalance is arranged between the balancing pins of the two functional integrated circuits FIC_n+1 and FIC_n. According to the sending direction of the control signal FOSC, the two switching networks SNW implement upper-to-lower power balancing. First, the two switches S2 are closed and the two switches S1 are opened to establish the power balancing loop shown in FIG. 37A to balance the power of the battery pack P2 and the balancing capacitor Cbalance (storing energy). Next, the two switches S2 are opened and the two switches S1 are closed to establish the power balancing loop shown in FIG. 37B to balance the power of the battery pack P1 and the balancing capacitor Cbalance (releasing energy). In another embodiment of the present invention, when the terminal voltage Vbat_n+1 is greater than the terminal voltage Vbat_n by more than a preset value, the battery management system of the present invention activates a corresponding action to enable at least one functional integrated circuit FIC to implement the power balance (namely upper-to-lower power balance) of the battery pack P1 to battery pack P2 according to the sending direction of the control signal FOSC, such as the opposite direction of FOSC shown in FIGS. 37A and 37B. The two switching networks SNW implement upper-to-lower power balancing. First, the power balancing loop shown in FIG. 37B is established to balance the power of the battery pack P1 and the balancing capacitor Cbalance (storing energy). Then, the power balancing loop shown in FIG. 37A is established to balance the power of the battery pack P2 and the balancing capacitor Cbalance (releasing energy).

FIGS. 38A and 38B show power balancing circuit diagrams of a battery management system according to another embodiment of the present invention for implementing high-power series balancing management, which combines the three balancing capacitors Cbalance of the embodiments shown in FIG. 33, FIG. 34 and FIG. 37 above. In this embodiment of the present invention, each functional integrated circuit FIC has two balanced pins. The three balancing capacitors are respectively disposed in the functional integrated circuits FIC_n+1 and FIC_n and connected in parallel to the two balancing pins, and are disposed between the balancing pins of FIC_n+1 and the two balancing pins of FIC_n. Therefore, the two balancing pins of the two functional integrated circuits FIC are connected correspondingly, so that the three balancing capacitors Cbalance can be connected in parallel to increase the capacity of the balancing capacitor, which is helpful to implement the series balancing function between battery packs with higher power.

In one embodiment of the present invention, when the terminal voltage Vbat_n is greater than the terminal voltage Vbat_n+1 by more than a preset value, the battery management system of the present invention activates a corresponding action to enable at least one functional integrated circuit FIC to implement the power balance (namely lower-to-upper power balance) of the battery pack P2 to battery pack P1 according to the sending direction of the control signal FOSC. To simplify the complexity of FIG. 38, the functional integrated circuits FIC_n+1 and FIC_n only illustrate the power balancing circuit of the switching network SNW. According to the sending direction of the control signal FOSC, the two switching networks SNW implement lower-to-upper power balancing. First, the two switches S2 are closed and the two switches S1 are opened, so that the negative terminal of the battery pack P1 is electrically connected to an upper-to-lower contact Cu-d and the negative terminal of the battery pack P2 is electrically connected to a lower-to-upper contact Cd-u, so as to establish the power balancing loop shown in FIG. 38A to balance the power of the battery pack P2 and the three parallel balancing capacitors Cbalance (storing energy). Next, the two switches S2 are opened and the two switches S1 are closed, so that the positive terminal of the battery pack P1 is electrically connected to the upper-to-lower contact Cu-d and the positive terminal of the battery pack P2 is electrically connected to the lower-to-upper contact Cd-u, so as to establish the power balancing loop shown in FIG. 38B to balance the power of the battery pack P1 and the three parallel balancing capacitors Cbalance (releasing energy). In another embodiment of the present invention, when the terminal voltage Vbat_n+1 is greater than the terminal voltage Vbat_n by more than a preset value, the battery management system of the present invention activates a corresponding action to enable at least one functional integrated circuit FIC to implement the power balance (namely upper-to-lower power balance) of the battery pack P1 to battery pack P2 according to the sending direction of the control signal FOSC, such as the opposite direction of FOSC shown in FIGS. 38A and 38B. The two switching networks SNW implement upper-to-lower power balancing. First, the power balancing loop shown in FIG. 38B is established to balance the power of the battery pack P1 and the three parallel balancing capacitors Cbalance (storing energy). Then, the power balancing loop shown in FIG. 38A is established to balance the power of the battery pack P2 and the three parallel balancing capacitors Cbalance (releasing energy).

According to the embodiments shown in FIGS. 33, 34, 37 and 38 and the descriptions thereof, the switching network SNW of the functional integrated circuit FIC comprises an upper-to-lower power balancing circuit and a lower-to-upper power balancing circuit. In the embodiments of the present invention, “upper-to-lower” or “lower-to-upper” is used to describe the connection between adjacent battery cells, not to describe the balance of power levels. Likely, “left-to-right” or “right-to-left” is used to describe the connection between adjacent battery cells.

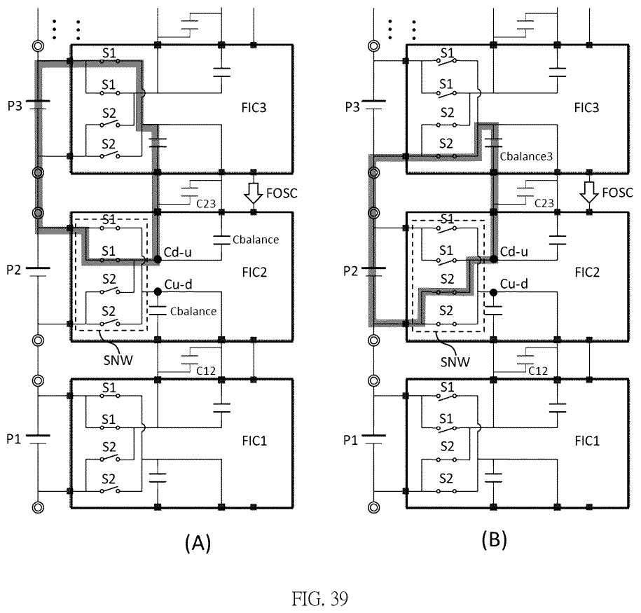

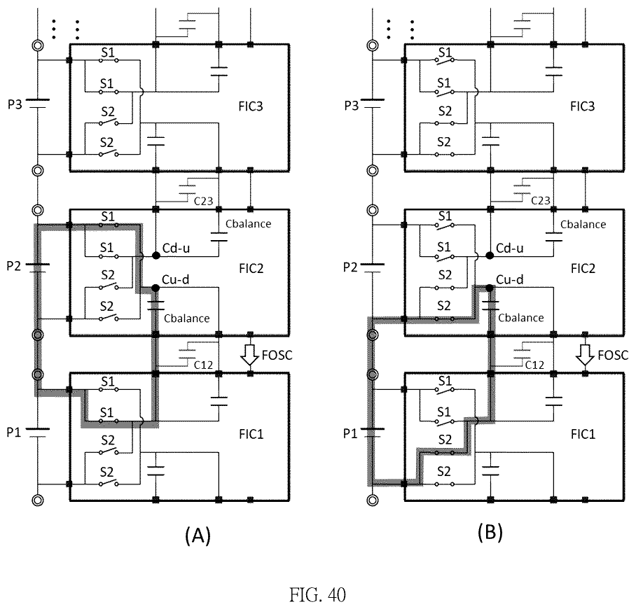

FIGS. 39A to 39B and FIGS. 40A to 40B illustrate a power balancing circuit diagram of a high-power series balancing management of a battery management system of the present invention. As shown in FIG. 38, two battery packs P1 and P2 are connected in series. When three battery packs P1, P2 and P3 are connected in series and each battery pack is respectively connected in parallel to a functional integrated circuit FIC1, FIC2 or FIC3, a battery management system is formed as shown in FIG. 39. Each functional integrated circuit is the same, and the two balancing pins and the synchronous control pins of two adjacent functional integrated circuits FIC are electrically connected correspondingly. Taking the battery pack P2 as an example, FIC3 is the upper functional integrated circuit relative to FIC2, and FIC1 is the lower functional integrated circuit relative to FIC2. FIC2 comprises a switching network SNW, two lower-to-upper balancing pins, two upper-to-lower balancing pins, a lower-to-upper synchronous control pin and an upper-to-lower synchronous control pin. The switching network is connected in parallel to a positive terminal and a negative terminal of the battery pack P2 via a positive pin and a negative pin. The switching network SNW includes an upper-to-lower power balancing circuit and a lower-to-upper power balancing circuit. The up-to-lower power balancing circuit includes switches S1 and S2 for switching the positive terminal and the negative terminal of the battery pack P2 to be electrically connected to an upper-to-lower contact Cu-d respectively, and the upper-to-lower contact Cu-d is electrically connected to two upper-to-lower balancing pins. The lower-to-upper power balancing circuit includes switches S1 and S2 for switching the positive terminal and the negative terminal of the battery pack P2 to be electrically connected to a lower-to-upper contact Cd-u respectively, and the lower-to-upper contact Cd-u is electrically connected to two lower-to-upper balancing pins. A balancing capacitor Cbalance is connected in parallel to the two upper-to-lower balancing pins, and another balancing capacitor Cbalance is connected in parallel to the two lower-to-upper balancing pins.

When the two lower-to-upper balancing pins of FIC2 are respectively electrically connected to the two upper-to-lower balancing pins of FIC3, an external balancing capacitor C23 is connected in parallel to the two lower-to-upper balancing pins of FIC2. When the two upper-to-lower balancing pins of FIC2 are respectively electrically connected to the two lower-to-upper balancing pins of FIC1, an external balancing capacitor C12 is connected in parallel to the two upper-to-lower balancing pins of FIC2. In addition, the lower-to-upper synchronous control pin of FIC2 is electrically connected to the upper-to-lower synchronous control pin of FIC3, and the upper-to-lower synchronous control pin of FIC2 is electrically connected to the lower-to-upper synchronous control pin of FIC1.

When the terminal voltage of battery pack P3 is greater than the terminal voltage of battery pack P2 by more than a preset value, the battery management system of the present invention activates a corresponding action to enable at least one functional integrated circuit FIC, and the sending direction of the control signal FOSC is transmitted from the upper-to-lower synchronous control pin of FIC3 to the lower-to-upper synchronous control pin of FIC2, as shown in FIG. 39. According to the sending direction of the control signal FOSC, FIC2 and FIC3 work together to achieve the power balance between the battery packs P3 and P2. First, the lower-to-upper power balancing circuit (with S2 opened and S1 closed) of the switching network SNW of FIC2 and the upper-to-lower power balancing circuit (with S2 opened and S1 closed) of the switching network SNW of FIC3 operate to establish a power balancing loop shown in FIG. 39A to balance the power of the battery pack P3 with the three parallel balancing capacitors (storing energy). Then, the lower-to-upper power balancing circuit (with S1 opened and S2 closed) of the switching network SNW of FIC2 and the upper-to-lower power balancing circuit (with S1 opened and S2 closed) of the switching network SNW of FIC3 operate to establish a power balancing loop shown in FIG. 39B to balance the power of the battery pack P2 with the three parallel balancing capacitors (releasing energy). On the other hand, when the terminal voltage of battery pack P2 is greater than the terminal voltage of battery pack P3 by more than a preset value, the sending direction of the control signal FOSC is transmitted from the lower-to-upper synchronous control pin of FIC2 to the upper-to-lower synchronous control pin of FIC3, as opposite to the direction of FOSC shown in FIG. 39. The switching networks of the two-functional integrated circuits FIC2 and FIC3 implement the power balance between P2 and P3. First, a power balance loop shown in FIG. 39B is established to balance the power of the battery pack P2 with the three parallel balancing capacitors (storing energy), and then a power balance loop shown in FIG. 39A is established to balance the power of the battery pack P3 with the three parallel balancing capacitors (releasing energy).

When the terminal voltage of battery pack P2 is greater than the terminal voltage of battery pack P1 by more than a preset value, the battery management system of the present invention activates a corresponding action to enable at least one functional integrated circuit FIC, and the sending direction of the control signal FOSC is transmitted from the upper-to-lower synchronous control pin of FIC2 to the lower-to-upper synchronous control pin of FIC1, as shown in FIG. 40. According to the sending direction of the control signal FOSC, the functional integrated circuits FIC1 and FIC2 work together to achieve the power balance between the battery packs P2 and P1. First, the upper-to-lower power balancing circuit (with S2 opened and S1 closed) of the switching network SNW of FIC2 and the lower-to-upper power balancing circuit (with S2 opened and S1 closed) of the switching network SNW of FIC1 operate to establish a power balancing loop shown in FIG. 40A to balance the power of the battery pack P2 with the three parallel balancing capacitors (storing energy). Then, the upper-to-lower power balancing circuit (with S1 opened and S2 closed) of the switching network SNW of FIC2 and the lower-to-upper power balancing circuit (with S1 opened and S2 closed) of the switching network SNW of FIC1 operate to establish a power balancing loop shown in FIG. 40B to balance the power of the battery pack P1 with the three parallel balancing capacitors (releasing energy). On the other hand, when the terminal voltage of battery pack P1 is greater than the terminal voltage of battery pack P2 by more than a preset value, the sending direction of the control signal FOSC is transmitted from the lower-to-upper synchronous control pin of FIC1 to the upper-to-lower synchronous control pin of FIC2, as opposite to the direction of FOSC shown in FIG. 40. The switching networks of the two-functional integrated circuits FIC1 and FIC2 implement lower-to-upper power balancing. First, the power balancing loop shown in FIG. 40B is established to balance the charge of the battery pack P1 with the three parallel balancing capacitors (storing energy), and then the power balancing loop shown in FIG. 40A is established to balance the power of the battery pack P2 with the three parallel balancing capacitors (releasing energy).

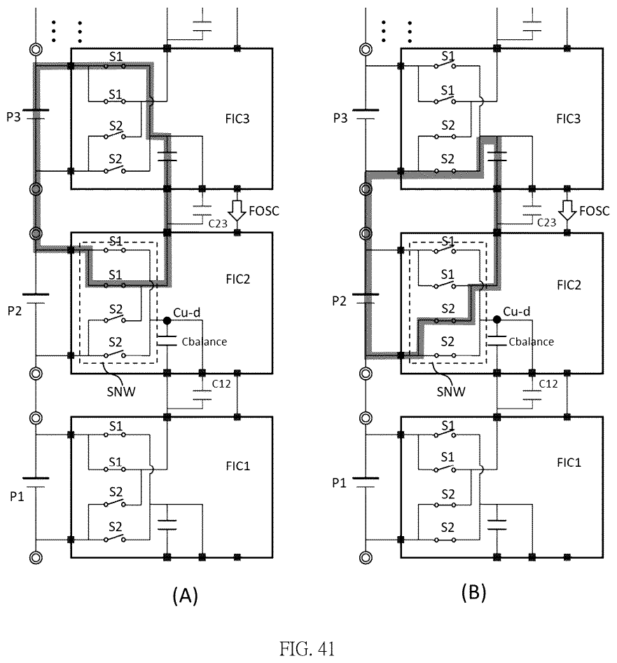

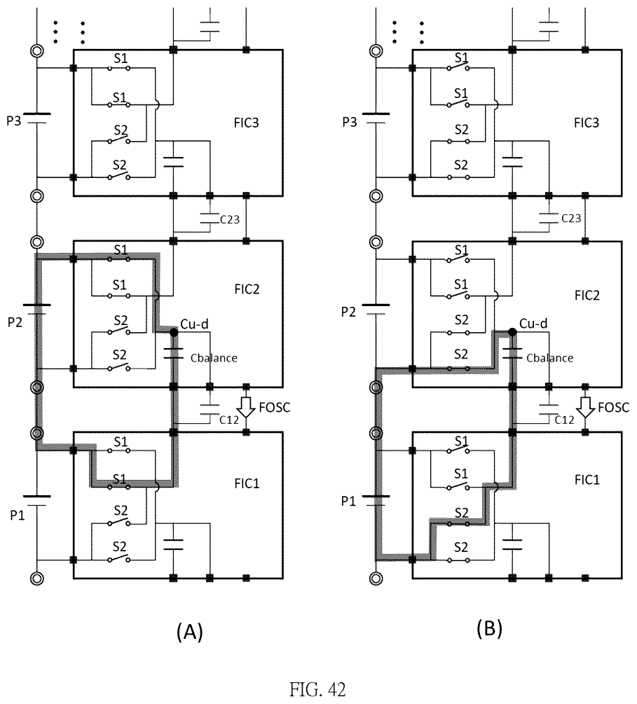

FIGS. 41A to 41B and FIGS. 42A and 42B illustrate another power balancing circuit diagram of high-power series balancing management of a battery management system of the present invention. When three battery packs P1, P2, and P3 are connected in series, and each battery pack is respectively connected in parallel to a functional integrated circuit FIC1, FIC2 or FIC3, a battery management system is formed as shown in FIG. 41. Each functional integrated circuit is the same, and the two balancing pins and the synchronous control pins of two adjacent functional integrated circuits FIC are electrically connected correspondingly. Taking the battery pack P2 as an example, FIC3 is the upper functional integrated circuit of FIC2, and FIC1 is the lower functional integrated circuit of FIC2. FIC2 includes a switching network SNW, a lower-to-upper balancing pin, two upper-to-lower balancing pins, a lower-to-upper synchronous control pin and an upper-to-lower synchronous control pin. The switching network is connected in parallel to a positive terminal and a negative terminal of the battery pack P2 via a positive pin and a negative pin. The switching network SNW includes an upper-to-lower power balancing circuit and a lower-to-upper power balancing circuit. The upper-to-lower power balancing circuit includes switches S1 and S2 for switching the positive terminal and the negative terminal of the battery pack P2 to be electrically connected to an upper-to-lower contact Cu-d respectively, and the upper-to-lower contact Cu-d is electrically connected to two upper-to-lower balancing pins. The lower-to-upper power balancing circuit includes switches S1 and S2 for respectively switching the positive terminal and the negative terminal of the battery pack P2 to be electrically connected to the lower-to-upper balancing pins. A balancing capacitor Cbalance is connected in parallel to the two upper-to-lower balancing pins.

When the lower-to-upper balancing pin of FIC2 is electrically connected to one of the upper-to-lower balancing pins of FIC3, an external balancing capacitor C23 is connected in parallel between the lower-to-upper balancing pin of FIC2 and another upper-to-lower balancing pin of FIC3. When one of the upper-to-lower balancing pins of FIC2 is electrically connected to the lower-to-upper balancing pin of FIC1, an external balancing capacitor C12 is connected in parallel between the other upper-to-lower balancing pin of FIC2 and the lower-to-upper balancing pin of FIC1. In addition, the lower-to-upper synchronous control pin of FIC2 is electrically connected to the upper-to-lower synchronous control pin of FIC3, and the upper-to-lower synchronous control pin of FIC2 is electrically connected to the lower-to-upper synchronous control pin of FIC1.

When the terminal voltage of battery pack P3 is greater than the terminal voltage of battery pack P2 by more than a preset value, the battery management system of the present invention activates a corresponding action to enable at least one functional integrated circuit FIC, and the sending direction of the control signal FOSC is transmitted from the upper-to-lower synchronous control pin of FIC3 to the lower-to-upper synchronous control pin of FIC2, as shown in FIG. 41. According to the sending direction of the control signal FOSC, the functional integrated circuits FIC2 and FIC3 work together to achieve the power balance between the battery packs P3 and P2. First, the lower-to-upper power balancing circuit (with S2 opened and S1 closed) of the switching network SNW of FIC2 and the upper-to-lower power balancing circuit (with S2 opened and S1 closed) of the switching network SNW of FIC3 operate to establish a power balancing loop shown in FIG. 41A to balance the power of the battery pack P3 with the two parallel balancing capacitors (storing energy). Then, the lower-to-upper power balancing circuit (with S1 opened and S2 closed) of the switching network SNW of FIC2 and the upper-to-lower power balancing circuit (with S1 opened and S2 closed) of the switching network SNW of FIC3 operate to establish a power balancing circuit shown in FIG. 41B to balance the power of the battery pack P2 and the two parallel balancing capacitors (releasing energy). On the other hand, when the terminal voltage of battery pack P2 is greater than the terminal voltage of battery pack P3 by more than a preset value, the battery management system of the present invention activates a corresponding action to enable at least one functional integrated circuit FIC, and the sending direction of the control signal FOSC is transmitted from the lower-to-upper synchronous control pin of FIC2 to the upper-to-lower synchronous control pin of FIC3, which is opposite to the direction of FOSC shown in FIG. 41. The switching networks of the two-functional integrated circuits FIC2 and FIC3 implement the power balance between P2 and P3. First, the power balance loop shown in FIG. 41B is established to balance the power of the battery pack P2 with the two parallel balancing capacitors (storing energy), and then the power balance loop shown in FIG. 41A is established to balance the power of the battery pack P3 with the two parallel balancing capacitors (releasing energy).

When the terminal voltage of battery pack P2 is greater than the terminal voltage of battery pack P1 by more than a preset value, the battery management system of the present invention activates a corresponding action to enable at least one functional integrated circuit FIC, and the sending direction of the control signal FOSC is transmitted from the upper-to-lower synchronous control pin of FIC2 to the lower-to-upper synchronous control pin of FIC1, as shown in FIG. 42. According to the sending direction of the control signal FOSC, the functional integrated circuits FIC1 and FIC2 work together to achieve the power balance between the battery packs P2 and P1. First, the upper-to-lower power balancing circuit (with S2 opened and S1 closed) of the switching network SNW of FIC2 and the lower-to-upper power balancing circuit (with S2 opened and S1 closed) of the switching network SNW of FIC1 operate to establish a power balancing loop shown in FIG. 42A to balance the power of the battery pack P2 and the two parallel balancing capacitors (storing energy). Then, the upper-to-lower power balancing circuit (with S1 opened and S2 closed) of the switching network SNW of FIC2 and the lower-to-upper power balancing circuit (with S1 opened and S2 closed) of the switching network SNW of FIC1 operate to establish a power balancing loop shown in FIG. 42B to balance the power of the battery pack P1 with the two parallel balancing capacitors (releasing energy). On the other hand, when the terminal voltage of battery pack P1 is greater than the terminal voltage of battery pack P2 by more than a preset value, the battery management system of the present invention activates a corresponding action to enable at least one functional integrated circuit FIC, and sending indication direction of the control signal FOSC is transmitted from the lower-to-upper synchronous control pin of FIC1 to the upper-to-lower synchronous control pin of FIC2, which is opposite to the direction of FOSC shown in FIG. 42. The switching networks of the two-functional integrated circuits FIC1 and FIC2 implement lower-to-upper power balancing. First, the power balancing loop shown in FIG. 42B is established to balance the power of the battery pack P1 with the two parallel balancing capacitors (storing energy), and then the power balancing loop shown in FIG. 42A is established to balance the power of the battery pack P2 with the two parallel balancing capacitors (releasing energy).

From the embodiments shown in FIGS. 33 to 42, the series balancing circuit for battery packs according to the present invention utilizes the electrode connection between two battery packs and at least one balancing pin connection between two functional integrated circuits FIC to establish a power balancing loop, thereby achieving upper-to-lower power balancing and lower-to-upper power balancing between the two battery packs connected in series.

However, it should be understood that the various specific embodiments of the present invention are only for illustrative purposes, and various changes may be made without departing from the scope and spirit of the invention, and all should be included in the scope of the invention. Therefore, the specific embodiments described in this specification are not intended to limit the invention, and the true scope and spirit of the invention are disclosed in the following claims.

What is claimed is:

1. A battery management IC, adapted for performing power management by connecting in parallel to at least one battery cell or by connecting in parallel to a plurality of battery cells connected in series, the battery management IC comprising:
at least one loop switch, arranged in a charging loop or a discharging loop of the at least one battery cell or the plurality of battery cells connected in series;
at least one voltage measurement circuit, configured to measure an open-loop voltage of each battery cell when the loop switch causes the charging loop or the discharging loop opened; and
a management unit, configured to determine state of charge of each battery cell according to the open-loop voltage Vopen of each battery cell.

2. A battery management IC, adapted for performing power management by connecting at least one battery cell in parallel or connecting in parallel to a plurality of battery cells connected in series, the battery management IC comprising:
at least one voltage measurement circuit, configured to measure a terminal voltage of the battery cell connected in parallel to the battery management IC;
at least one temperature measurement circuit, configured to measure a battery temperature of the battery cell connected in parallel to the battery at least one current measurement circuit, configured to measure a charge current or a discharge current of the battery cell connected in parallel to the battery management IC; and
a calculation unit, configured to calculate an open-loop voltage and a battery internal resistance of the battery cell associated with the battery temperature according to the terminal voltage of each battery cell, the battery temperature and the charge current or discharge current of each battery cell;
wherein the battery management IC synchronously measures the terminal voltage, the battery temperature and the charge current or discharge current, the battery management IC determines state of charge of each battery cell according to the open-loop voltage which is associated with the battery temperature.

3. A battery management system, configured to manage a plurality of battery cells to discharge for a terminal device or to charge from the terminal device, the battery management system comprising:
a plurality of battery cells, in one of a series connection, a parallel connection, a series-parallel connection and a parallel-series connection, configured to be charged or discharged; and
at least one battery management IC of claim 1 or 2;
wherein the battery management system manages the power of the plurality of battery cells according to the open-loop voltage of each battery cell provided by the battery management IC.

4. A battery management IC, adapted for performing power management by connecting at least one battery cell in parallel or connecting in parallel to a plurality of battery cells connected in series, the battery management IC comprising:
at least one positive pin and at least one negative pin, respectively electrically connected to a positive electrode and a negative electrode of a corresponding battery cell;
at least a pair of sensing pins, connecting in parallel to a temperature sensor for the corresponding battery cell;
a balancing resistor and a parallel-connected switch connected in series, connecting the at least one battery cell in parallel or connecting in parallel to the plurality of battery cells connected in series; and
an loop switch, arranged in a charging loop or discharging loop of the at least one battery cell or the plurality of battery cells connected in series;
wherein, the battery management IC measures an open-loop voltage of each battery cell associated with the battery temperature through the sensing pins when the loop switch cuts off the charging loop or the discharging loop.

5. A battery management IC, adapted for performing power management by connecting at least one battery cell in parallel or connecting in parallel to a plurality of battery cells connected in series, the battery management IC comprising:
at least one positive pin and at least one negative pin, respectively electrically connected to a positive electrode and a negative electrode of a corresponding battery cell;
at least a pair of sensing pins, connecting in parallel to a temperature sensor for the corresponding battery cell;
a balancing resistor and a parallel-connected switch connected in series, connecting the at least one battery cell in parallel or connecting in parallel to the plurality of battery cells connected in series; and
a control pin, electrically connecting to a loop switch, the loop switch being arranged in a charging loop or a discharging loop of the at least one battery cell or the plurality of battery cells connected in series, and the loop switch configured to receive a control via the control pin to cutoff a charge current of the charging loop or a discharging current of the discharging loop;
wherein the battery management IC measures an open-loop voltage of each battery cell associated with the battery temperature through the sensing pins when the control pin controls the loop switch to cut off the charging loop or the discharging loop.

6. A method for calculating a battery internal resistance, implemented by a battery management IC connecting at least one battery cell in parallel or connecting in parallel to a plurality of battery cells connected in series to perform power management, the method comprising:
controlling a loop switch to cut off a charging loop or a discharging loop of the battery cell so that the battery management IC measures an open-loop voltage of each battery cell;
controlling the loop switch to cut off the charging loop or the discharging loop of the battery cell, and controlling a parallel-connected switch to conduct a circuit parallel to the at least one battery cell or the plurality of battery cells connected in series, so that the battery management IC synchronously measures each battery terminal voltage and a battery current; and
calculating a battery internal resistance of each battery cell according to the open-loop voltage of each battery cell, the battery terminal voltage and the battery current.

7. A method for calculating a battery internal resistance, implemented by a battery management IC connecting at least one battery cell in parallel or connecting in parallel to a plurality of battery cells connected in series to perform power management, the method comprising:
controlling a loop switch to conduct a charging loop or a discharging loop of the battery cell, and controlling a parallel-connected switch to cut off a circuit parallel to the at least one battery cell or the plurality of battery cells connected in series, so that the battery management IC synchronously measures each battery terminal voltage and a battery current; and
calculating a battery internal resistance of each battery cell according to the battery terminal voltage and the battery current measured twice synchronously for each battery cell.

8. A battery pack, comprising:
a positive electrode terminal and a negative electrode terminal;
a first battery cell or a first battery group, having a first positive electrode and a first negative electrode;
a second battery cell or a second battery group, having a second positive electrode and a second negative electrode; and
a battery management IC;
pin and a second negative pin, the positive pin electrically connected to the first positive electrode, the second positive electrode and the positive electrode terminal, the first negative pin electrically connected to the first negative electrode of the first battery cell or the first battery group, the second negative pin electrically connected to the second negative electrode of the second battery cell or the second battery group;
wherein the battery management IC temporarily configured to cut off a charging loop or a discharging loop of the second battery cell or the second battery group during the charging or discharging of the first battery cell or the first battery group, so that the battery management IC measures each open-loop voltage of the second battery cell or the second battery group and determines state of charge of the second battery cell or the second battery group accordingly.

9. The battery pack of claim 8, wherein during the period when the battery management IC controls a first loop switch to conduct the charging loop or the discharging loop of the first battery cell or the first battery group, the battery management IC controls a second loop switch to temporarily cut off the charging loop or the discharging loop of the second battery cell or the second battery group, and the first loop switch is arranged between the first negative pin and the negative electrode terminal, and the second loop switch is arranged between the second negative pin and the negative electrode terminal.

10. A battery management IC, comprising:
a positive pin, a first negative pin and a second negative pin;
wherein the positive pin is configured to electrically connect to a first positive electrode of a first battery cell or a first battery group and a second positive electrode of a second battery cell or a second battery group, the first negative pin is configured to electrically connect to a first negative electrode of the first battery cell or the first battery group, the second negative pin is configured to electrically connect to a second negative electrode of the second battery cell or the second battery group;
wherein during charging or discharging of the first battery cell or the first battery group, the battery management IC cuts off a charging loop or a discharging loop of the second battery cell or the second battery group, so that the battery management IC measures each open-loop voltage of the second battery cell or the second battery group and determines state of charge of the second battery cell or the second battery group accordingly.

11. A battery management system, comprising:
a plurality of battery packs, connected in a parallel-series form and configured to discharge for a terminal device or charge via the terminal device, wherein each battery pack comprises a plurality of battery cells and a battery management IC, the battery cells are connected in a series;
wherein during charging or discharging period of each battery pack, the battery management IC receives an external instruction, and the external instruction causes the battery management IC to cut off a charging loop during the charging period or a discharging loop during the discharging period through a loop switch, and during the period when the charging loop or the discharging loop is cutoff, the battery management IC measures an open-loop voltage of each battery cell and determines state of charge of each battery cell accordingly.

12. A battery pack, comprising:
a positive electrode terminal and a negative electrode terminal;
a first battery cell or a first battery group having a first positive electrode and a first negative electrode;
a second battery cell or a second battery group having a second positive electrode and a second negative electrode; and
a battery management IC;
wherein the battery management IC comprises a first positive pin, a first negative pin, a second positive pin and a second negative pin, wherein the first positive pin is electrically connected to the first positive electrode, the second positive pin is electrically connected to the second positive electrode, the first negative pin is electrically connected to the first negative electrode, and the second negative pin is electrically connected to the second negative electrode, a first charge and discharge circuit is electrically connected between the positive electrode terminal and the first positive pin, a second charge and discharge circuit is electrically connected between the positive electrode terminal and the second positive pin, a first loop switch is electrically connected between the first negative pin and the negative electrode terminal, a second loop switch is electrically connected between the second negative pin and the negative electrode terminal.

13. A battery pack, comprising:
at least one positive electrode terminal, a first negative electrode terminal and a second negative electrode terminal;
a first battery cell or a first battery group having a first positive electrode and a first negative electrode;
a second battery cell or a second battery group having a second positive electrode and a second negative electrode; and
a battery management IC;
wherein the battery management IC comprises at least one positive pin, a first negative pin, and a second negative pin, wherein the at least one positive pin is electrically connected to one of the first positive electrode and the second positive electrode, the first negative pin is electrically connected to the first negative electrode, and the second negative pin is electrically connected to the second negative electrode, a switching circuit is configured to selectively switch the first negative electrode terminal and the second negative electrode terminal to be electrically connected to the first negative electrode or the second negative electrode, so as to selectively cut off a charging loop and a discharging loop of the first and second battery cells or the first and second battery groups.

14. A battery management IC adapted for managing a plurality of battery cells to discharge for a terminal device or charge via the terminal device, comprising:
a plurality of pins, configured to connect in parallel to each corresponding battery cell of a battery pack consisting of the plurality of battery cells connected in series;
a plurality of series balancing capacitors, each configured to balance adjacent battery cells;
a switching network, electrically connecting the plurality of electrode pins and the plurality of series balancing capacitors, and switching the electrode pin between the adjacent battery cells to electrically connect to the corresponding series balancing capacitor in response to a corresponding action; and
a loop switch, arranged in a charging loop and a discharging loop of the battery pack, and the loop switch can temporarily cut off the charging loop and the discharging loop to measure state of charge of each battery cell.

15. The battery management IC of claim 14 further comprises:
a common pin, configured to electrically connect to another common pin of another battery management IC; and
a parallel balancing capacitor, configured to balance a plurality of battery packs connected in parallel;
wherein the switching network is configured to selectively switch the parallel balancing capacitor to be electrically connected in parallel to the battery pack or at least one other battery pack in response to the corresponding action.

16. A battery management system, adapted for managing charging and discharging of battery packs, comprising:
a plurality of battery packs, connected in parallel to discharge for a terminal device or to charge via the terminal device, each battery pack having a plurality of battery cells connected in series; and
a plurality of the battery management ICs of claim 14 or 15, wherein the battery management IC implements a series power balancing function to the plurality of battery cells in a battery pack and/or a parallel power balancing function to the plurality of battery packs in response to the corresponding action.

17. A functional IC, adapted for managing charging and discharging balance of a plurality of battery cells connected in series, comprising:
a positive pin and a negative pin, configured to connect in parallel to a positive electrode and a negative electrode of at least one battery unit or a plurality of battery units connected in series;
at least one upper-to-lower balancing pin, configured to electrically connect at least one lower-to-upper balancing pin of a lower functional IC;
at least one lower-to-upper balancing pin, configured to electrically connect at least one upper-to-lower balancing pin of an upper functional IC; and
a switching network, configured to switch the positive pin and the negative pin to be electrically connected to the at least one lower-to-upper balancing pin, and switch the positive pin and the negative pin to be electrically connected to the at least one upper-to-lower balancing pin;
wherein, a balancing capacitor is electrically connected between the switching network and the at least one lower-to-upper balancing pin, between the switching network and the at least one upper-to-lower balancing pin, or between the at least one upper-to-lower balancing pin of the functional IC and the lower-to-upper balancing pin of the lower functional IC with another balancing capacitor electrically connected between the at least one lower-to-upper balancing pin of the functional IC and the upper-to-lower balancing pin of the upper functional IC;
wherein the functional IC, the upper functional IC and the lower functional IC have same pin configuration.

18. A functional IC, adapted for managing charging and discharging balance of battery cells connected in series, comprising:
a positive pin and a negative pin, configured to connected in parallel to a positive electrode and a negative electrode of at least one battery cell or a plurality of battery cells connected in series;
at least one upper-to-lower balancing pin, configured to electrically connect a lower-to-upper balancing pin of a lower functional IC;
at least one lower-to-upper balancing pin, configured to electrically connect an upper-to-lower balancing pin of an upper functional IC; and
a switching network, configured to switch the positive pin and the negative pin to respectively electrically connect to a lower-to-upper contact, and switch the positive pin and the negative pin to respectively electrically connect to an upper-to-lower contact;
wherein the functional IC further comprises a balancing capacitor connected in one of the following forms where:
the balancing capacitor is electrically connected between the lower-to-upper contact and the lower-to-upper balancing pin, and the upper-to-lower contact is electrically connected to the upper-to-lower balancing pin;
the balancing capacitor is electrically connected between the upper-to-lower contact and the upper-to-lower balancing pin, and the lower-to-upper contact is electrically connected to the lower-to-upper balancing pin; and
the balancing capacitor is electrically connected between the upper-to-lower balancing pin and the lower-to-upper balancing pin of the lower functional IC with another balancing capacitor electrically connected between the lower-to-upper balancing pin and the upper-to-lower balancing pin of the upper functional IC, and the upper-to-lower contact is electrically connected to the upper-to-lower balancing pin and the lower-to-upper contact is electrically connected to the lower-to-upper balancing pin;
wherein the functional IC, the upper functional IC and the lower functional IC have same pin configuration.

19. A functional IC, adapted for managing charging and discharging balance of battery cells connected in series, comprising:
a positive pin and a negative pin, configured to connect in parallel to a positive electrode and a negative electrode of at least one battery cell or a plurality of battery cells connected in series;
at least one upper-to-lower balancing pin, configured to electrically connect a pair of lower-to-upper balancing pins of a lower functional IC;
a pair of lower-to-upper balancing pins, configured to electrically connect at least one upper-to-lower balancing pin of an upper functional IC; and
a switching network, configured to switch the positive pin and the negative pin to electrically connect to the pair of lower-to-upper balancing pins, and switch the positive pin and the negative pin to electrically connect to the at least one upper-to-lower balancing pin;
wherein a balancing capacitor is electrically connected between the pair of lower and upper balancing pins;
wherein the functional IC, the upper functional IC and the lower functional IC have same pin configuration.

20. A battery management system, comprising:
a plurality of battery cells connected in series and the functional ICs of claim 17, 18 or 19, each functional IC connects in parallel to at least one corresponding battery cell;
wherein the battery management system enables at least one functional IC in response to a corresponding action to manage the charging and discharging balance between adjacent battery cells connected in series.
